(19) United States
(12) Patent Application Publication
(10) Pub. No.: US 2020/0279389 A1
(43) Pub. Date: Sep. 3, 2020

(54) OBJECT MEASUREMENT SYSTEM

(71) Applicant: C 3 Limited, Taunga (NZ)

(72) Inventors: Geoffrey Peter McIver, Welcome Bay (NZ); Aaron Barry Reid, Petone (NZ); Evan Ryan Hirst, Korokoro (NZ)

(21) Appl. No.: 15/733,100

(22) PCT Filed: Nov. 16, 2018
(86) PCT No.: PCT/IB2018/059019

§ 371 Date: May 15, 2020

(30) Foreign Application Priority Data
Nov. 17, 2017 (NZ) 737427

(51) Int. Cl. G06T 7/62; G01B 11/08; G06T 7/143; G01B 11/00; G01B 11/02; G06K 7/14; G06K 7/10

(52) U.S. Cl. CPC G06T 7/62; G01B 11/08; G06T 7/143; G01B 11/002; G06K 7/1413; G06K 7/1443; G06K 7/10722; G06K 7/10861; G06K 7/1417; G01B 11/022

(57) ABSTRACT

A log measurement system for measuring individual logs, each log comprising a log-end face with an applied reference marker of known characteristics. The system includes an image capture system operable or configured to capture a digital image or images of the log-end face of a log to generate a log-end image capturing the log-end face and reference marker. The system also includes an image processing system that is operable or configured to process the captured log-end image to detect or identify the log-end boundary of the log and generate measurement data associated with the log-end boundary in real-world measurement units based on the known characteristics of the reference marker.

### FIELD OF THE INVENTION

The invention relates to a measuring system which may be applied to measuring objects, including but not limited to a log measurement system for use in the forestry industry for log scaling.

### BACKGROUND TO THE INVENTION

The log export industry in New Zealand and many other countries is required to count and barcode every log that is exported. After harvest, logs for export are typically delivered to a port on logging trucks or trailers. Upon arrival at the port, the load of logs on each truck is processed at a checkpoint or processing station. Typically, the number of logs in each load is counted and various measurements on each individual log are conducted to scale for volume and value, before being loaded onto ships for export.

Depending on the country, log scaling can be carried out according to various standards.

In New Zealand, almost all logs exported are sold on volume based on the Japanese Agricultural Standard (JAS). Scaling for JAS volume typically involves measuring the small end diameter of each log and its length, and then calculating JAS volume based on these measurements. The log counting and scaling exercise is currently very manual and labour intensive as it requires one or more log scalers per logging truck to count and scale each log manually. The log counting and scaling exercise can cause a bottleneck in the supply chain of the logs from the forest to the ship for export, or for supply to domestic customers.

To attempt to address the above issue, various automated systems have been proposed for assisting in automatic counting and measurement of logs. However, many of these currently proposed systems have various drawbacks which have limited their widespread adoption by the log export industry.

One such automated system is described in US patent application publication 2013/0144568. This system is a drive-through log measuring system for log loads on logging trucks. The system comprises a large structure mounting an array of lasers about its periphery and through which a logging truck may drive through. The system laser scans the log load on the back of the truck as it drives through and generates a 3D model of the log load. The 3D model is then processed to extract various characteristics of the logs, such as log diameters. This system is very large and expensive.

Another automated system for measuring logs is described in international PCT patent application publication WO 2005/080949. This system uses a stereo vision measuring unit mounted to a vehicle that is driven past a log pile on the ground and which captures stereo vision images of the log pile. The stereo images are then image processed to determine various physical properties of the logs, such as for measuring size and grading logs. This system requires a moving vehicle to move the measuring unit past the pile of logs situated on the ground and is not suited for measuring a log load in situ on a logging truck or log yard.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

It is an object of at least some embodiments of the invention to provide a system and method for measuring individual logs for log scaling, or a measurement system and method for other objects, and/or to at least provide the public with a useful choice.

In a first aspect, the invention broadly consists in a log measurement system for measuring individual logs, each log comprising a log-end face with an applied reference marker of known characteristics, the system comprising: an image capture system operable or configured to capture a digital image or images of the log-end face of a log to generate a log-end image capturing the log-end face and reference marker; and an image processing system that is operable or configured to process the captured log-end image to detect or identify the log-end boundary of the log and generate measurement data associated with the log-end boundary in real-world measurement units based on the known characteristics of the reference marker.

In an embodiment, the image capture system comprises one or more image sensors. In one configuration, the image capture system comprises a single image sensor. By way of example, the image sensor may be in the form of a digital camera that is operable to capture static and/or moving images. In one configuration, the digital camera is a monochrome camera. In another configuration, the digital camera is a colour camera.

In one embodiment, the image sensor of the image capture system is provided in a portable scanning system that is manually operable by an operator or user to capture the log-end images of logs. In this embodiment, the portable scanning system may comprise a handheld imaging device that mounts or carries the image sensor, such as a digital camera. In this embodiment, the handheld imaging device may comprise a main housing and a handle part or portion for gripping and holding by a user or operator. In this embodiment, the handheld imaging device may further comprise a camera controller that is operable to control the operation and settings of the digital camera.

In one embodiment, the image capture system is configured or operable to capture log-end images that each comprise a single log-end of a single log within the image.

In an embodiment, the portable scanning system may comprise a handheld imaging device that is operatively connected for power supply and data communication or transfer to a belt assembly comprising a main controller and power supply. In one configuration, the handheld imaging device is operatively connected to the components of the belt assembly by hardwiring such as cabling. In other configurations, it will be appreciated that the data communication between the handheld imaging device and main controller of the belt assembly may be over a wireless data connection.

In an embodiment, the handheld imaging device may further comprise a guidance system that is operable to project a guidance pattern onto and/or adjacent the log surfaces being imaged to assist the user operating the image capture system. In one configuration, the guidance system may comprise one or more light sources for projecting one or more light patterns onto the log surfaces. In one embodiment, the guidance system may be a laser guidance system to assist the operator during the image capture of the log-end images. The laser guidance system may comprise one or more operable lasers that are operable and configured to project a laser guidance pattern onto the target log-end faces of the logs being imaged. In one configuration, the laser guidance pattern may comprise upper and lower horizontal or parallel laser guide lines or stripes, and a central laser marker or dot located centrally between the upper and lower laser guide lines. In this embodiment, the laser guidance system may be configured to project the laser guidance pattern with reference to the digital camera field of view or otherwise be aligned with or relative to the digital camera field of view.

In an embodiment, the handheld imaging device may further comprise an operable trigger switch to initiate image capture by the digital camera. In one configuration, the operable trigger switch may be configured to initiate the laser guidance system along with the image capture by the digital camera. In one configuration, the trigger switch may be a dual stage switch with the first stage initiating the laser guidance system and initiating the digital camera to automatically adjust its camera settings ready for image capture, and the second stage initiating the image capture by the digital camera.

In an embodiment, the handheld imaging device may comprise a docking cradle or station for receiving a separate portable scanner device that is operable to read ID codes or reference tickets or tags such as barcodes, QR codes, two-dimensional codes, or datamatrix codes for example.

In another embodiment, the image capture system may comprise a robotic system or automatic scanning system that carries the image sensor sequentially one by one relative to the logs of a log load or log pile to sequentially capture a log-end image of each log-end in the log load.

In another embodiment, the image capture system maybe a fixed or stationary image capture station comprising the image sensor, wherein the image capture station is situated or located adjacent a conveyor that moves logs past the image sensor to enable the image sensor to capture an image of the log-end face of each log as it passes the image capture station.

In an embodiment, the reference marker is of known shape and dimensions.

In an embodiment, the reference marker may further comprise or is in the form of an ID code representing unique ID information associated with the log to which it is attached. In this embodiment, the reference marker may provide or serve the dual function of providing an ID code for the log and also providing a scaling reference for converting or transforming the data from the 2D image-pixel plane of the captured log-end images to the real-world measurement plane.

In an embodiment, the reference marker is provided on a printed reference ticket that is applied or fixed to the log-end face of the log being imaged.

In an embodiment, the reference ticket may provide an ID code that is distinct or independent of the reference marker. In this embodiment, the reference ticket may comprise a portion that provides the ID code, and a portion that provides the reference marker.

In an embodiment, the reference marker is a one or two-dimensional digital ID code such as a barcode, QR code, two-dimensional matrix code, datamatrix code or the like.

In an embodiment, the reference marker is a 2-D datamatrix code of known size and/or shape. In one configuration, the datamatrix code is provided with distinct corner regions or corners for detection by the image processing algorithms, the locations of the corner regions in the image being used to covert the image-pixel plane data to the real-world measurement plane. By way of example, this conversion or transformation may be via object point of reference photogrammetry techniques or processes.

In an embodiment, the image capture system is configured to implement one or more image capture algorithms during the image capture process.

In one embodiment, the image capture algorithm is configured to process a series of log-end images captured by the digital camera of a log-end face until a log-end image of sufficient quality based on predetermined criteria is obtained. In this embodiment, the image capture algorithms may be configured to terminate the image capture process once an image of sufficient quality is obtained for an individual log. In some embodiments, the image processing criteria for an adequate log-end image may comprise any one or more of the following: brightness, sharpness, readability of the ID code, location detection of the reference marker (e.g. corner region location detection) or the like.

In one embodiment, the image capture system may be a separate system that is in data communication with the image processing system. In other embodiments, the image capture system and image processing system may be integrated as a single or integrated log measurement system.

In an embodiment, the image processing system is configured to process the or each log-end image and generate a log-end boundary polygon representing the log-end boundary from which measurement data may be generated for each individual log based on its log-end image. In one embodiment, the log-end boundary polygon generated may represent the overbark log-end boundary. In another embodiment, the log-end boundary polygon generated may represent the underbark log-end boundary at the wood-bark boundary.

In an embodiment, the image processing system may be configured to execute image processing algorithms to extract the log-end boundary polygon.

In one embodiment, the image processing system is configured to execute a log area cropping algorithm upon the original log-end image captured by the digital camera to generate a cropped log-end image. In one configuration, the cropped log-end image is generated using a log region detection algorithm based on a cascade classifier.

In an embodiment, the image processing system is configured to generate a log probability model based on the output of the cascade classifier. In this configuration, the log probability model comprises data representing or being indicative of the probabilistic image regions or locations within the log-end image that are likely to represent the log or log-end boundary (e.g. regions or contours of interest). In some embodiments, this log probability model is used as an input for subsequent image processing algorithms or functions to assist in identifying the log-end boundary. In some configurations, the log probability model or accuracy of the log probability model increases as the cascade classifier processes additional log-end images such that the accuracy of the log probability model increases as the cascade classifier dataset of images increases. In some configurations, the log probability model is continuously or periodically updated or refined as the cascade classifier processes further log-end images thereby further training the cascade classifier and log probability model by machine learning.

In one embodiment, the image processing system may be configured to generate a log-end boundary polygon by applying an image contour detection and segmentation algorithm to the log-end image. In one configuration, the image contour detection and segmentation algorithm may generate the log-end boundary polygon based at least partly on the log probability model generated by the cascade classifier. In one configuration, the image contour detection and segmentation algorithm may be based on an ultra-metric contour map (UCM) process.

In one embodiment, the image contour detection and segmentation algorithm is configured to generate a UCM region map of the log-end image, and then apply a splitting and subsequent merging process of the regions to identify the log-end boundary within the log-end image. In one configuration, either the splitting or merging process, or both, are based at least partly on the log probability model generated by the cascade classifier. In this embodiment, the log-end boundary polygon generated may represent the overbark log-end boundary within the log-end image.

In one embodiment, the image processing system is configured to generate an overbark log-end boundary polygon by applying an image contour detection and segmentation algorithm to the cropped log-end image. In one configuration, the contour detection and segmentation algorithm is based on an ultra-metric contour map (UCM) process.

In one embodiment, the image processing system is configured to apply a repair algorithm to the overbark log-end boundary polygon to correct for any defects generated by the contour detection and segmentation algorithm process. In one configuration, the repair algorithm is based on fitting the log-end boundary polygon to a model, such as an elliptical model or based on the log probability model.

In one embodiment, the image processing system is configured to apply a refinement algorithm to the overbark log-end boundary polygon to convert it to an under underbark log-end boundary polygon. In one configuration, the refinement algorithm is based on image segmentation algorithm. In one configuration, the refinement algorithm processes edge segments or lines of the outerbark log-end boundary polygon and adjusts or refines any edge segments that are not located on or co-incident with the wood-bark boundary.

In another embodiment, the image processing system is configured to process each log-end image with an image processing algorithm in the form of an object instance segmentation algorithm. In one form, the object instance segmentation algorithm is based on a convolution neural network (CNN) algorithm. In one form, the object instance segmentation algorithm is based on a regional convolution neural network (R-CNN) algorithm such as, but not limited to, the Fast R-CNN or Faster R-CNN algorithms.

In one configuration, the image processing system is configured to process each log-end image with a mask region convolutional neural network (Mask R-CNN) algorithm to detect the log-end in the image and generate a log-end boundary data or polygon representing the detected or identified log-end in the log-end image. In this configuration, the Mask R-CNN is trained by data or a dataset representing log-end boundary data from log-end images.

In one form, the Mask R-CNN generates log-end boundary data in the form of pixel-level segmentation data. The pixel-level segmentation data represents which pixels in the log-end image belong to the detected log-end or the log-end boundary. The log-end boundary data may be configured to represent either the over-bark log-end boundary, or the under-bark log-end boundary.

In an embodiment, the image processing system is provided with a validation user interface that enables an operator to validate and edit the log boundary polygon generated. In one configuration, the validation user interface displays or presents the log-end image with an overlay or mask of the generated log-end boundary polygon. In one configuration, the validation user interface is operable for a user or operator to edit or adjust or move edge segments of the log-end boundary polygon if required.

In another embodiment, the image capture system comprises a sensor or sensors or a sensor system operable to capture the log-end images and depth data for each log-end image. In one form, the sensor system may comprise one or more image sensors for generating the log-end images and a depth sensor or sensors for generating the associated depth data for each log-end image. In another form, the sensor system may comprise a stereo camera system that is configured to generate the log-end images and associated depth data.

In one embodiment, the image processing system is configured to generate measurement data relating to the log-end of the log-end image based on the log-end boundary polygon in the image pixel plane. In this embodiment, the measurement data may be transformed or converted into real-world measurement units associated with a geometric measurement plane based on the depth data associated or linked with each respective log-end image. For example, the image-pixel plane data may be transformed or converted into the measurement plane based on the depth data associated or linked with the log-end image using image transformation algorithms.

In another embodiment, the image processing system may be configured to transform the log-end boundary polygon from the image-pixel plane into a real-world measurement plane based on the depth data associated or linked with each respective log-end image, and then generate real-world measurement data based on the real-world log-end boundary polygon or measurement plane data. In this embodiment, the image-pixel plane data may be transformed or converted into the measurement plane via the depth data using image transformation algorithms.

In an embodiment, the system is configured to detect and define the orientation of a log-face plane relative to the image plane from the log-end image based on depth data linked to the log-end image, and to generate the log-end boundary data based at least partly on the orientation of the detected log-face plane. In one configuration, the log-face plane detection may be implemented in the image capture system. In another configuration, the log-face plane detection may be implemented in the image processing system.

In one embodiment, the log-face plane detection may be implemented by a neural network configured to identify the log-end in the log-end image and process the depth data associated with at least a portion of the identified log-end region in the image to generate orientation data defining or representing the orientation of the log-face of the log-end relative to the image plane of the log-end image.

In an embodiment, the image processing system is configured to rotate log-end boundary data or polygon extracted from the log-end image based on the orientation of the log-face plane to enable real-world measurement data associated with the log-end boundary to be extracted.

In one embodiment, the image processing system is configured to generate measurement data relating to the log-end of the log-end image based on the log-end boundary polygon in the image pixel plane. In this embodiment, the measurement data may be transformed or converted into real-world measurement units associated with a geometric measurement plane based on the reference marker present within the log-end image. For example, the image-pixel plane data may be transformed or converted into the measurement plane via object-point of reference photogrammetry processes with respect to the known reference marker.

In another embodiment, the image processing system may be configured to transform the log-end boundary polygon from the image-pixel plane into a real-world measurement plane based on the reference marker present within the log-end image, and then generate real-world measurement data based on the real-world log-end boundary polygon or measurement plane data. In this embodiment, the image-pixel plane data may be transformed or converted into the measurement plane via object-point of reference photogrammetry processes with respect to the known reference marker.

In one form, the measurement data generated for each log end may comprise any one or more of the following: log end boundary centroid, minor axis, orthogonal axis and log diameters along the determined axes.

In an embodiment, the measurement system is further configured to output and/or store output data representing the measurement data generated for the logs in a data file or memory. In one example, the output data may comprise the log identification ID data and its associated measurement data, and optionally the log-end image and log boundary polygon data generated. In some configurations, the output data of the measurement system may comprise a log count should a batch of log-end images for a log pile or log stack be processed. In this configuration, the log count data may be derived or generated based on the number of unique ID codes or the reference tickets processed, the number of unique log-end boundary polygons generated, or some simply the number of processed log-end images in that there is one log-end image provided for processing for each individual log.

In one form, the output data may be stored in a data file or memory. In another form, the output data may be displayed on a display screen. In another form, the output data is in the form of a table and/or diagrammatic report.

In an embodiment, the logs may be in a log load that is in situ on a transport vehicle when scanned or imaged by the image capture system. The transport vehicle may be, for example, a logging truck or trailer, railway wagon, or log loader. In another embodiment, the logs may be in a log load resting on the ground or another surface, such as a log cradle for example.

In an embodiment, the reference markers are provided on only the small end of each of the logs in the log load.

In an embodiment, the log measurement system further comprises an operable powered carrier system to which the image capture system is mounted or carried, and wherein the carrier system is configured to move the image capture system relative to logs in a log load to image the log-end faces of the logs either automatically or in response to manual control by an operator.

In another embodiment, the log measurement system further comprises a conveyor or carriage system that is configured or operable to transport or move the logs past the image capture system so that the log-end images of the logs may be captured one by one as they pass the image capture system. In this embodiment, the image capture system may be an imaging station adjacent or near the conveyor system such that the image capture system has a field of view of the log-end is of the logs they pass on the conveyor system.

In a second aspect, the invention broadly consists in a log measurement system for measuring individual logs, each log comprising a log-end face with an applied reference marker of known characteristics, the system comprising: an image capture system operable or configured to: capture a digital image or images of the log-end face of a log to generate a log-end image capturing the log-end face and reference marker; and store and/or transmit the log-end image or images of the logs for subsequent image processing to generate measurement data associated with one or more physical properties of the log-end in real-world measurement units based on the known characteristics of the reference marker.

In a third aspect, the invention broadly consists in a log measurement system for measuring individual logs, each log comprising a log-end face with an applied reference marker of known characteristics, system comprising: an image processing system operable or configured to: receive log-end images comprising the log-end face of a log and associated reference marker; and process the log-end image to detect the log-end boundary of the log and generate measurement data associated with the log-end boundary in real-world measurement units based on the known characteristics of the reference marker.

The second and third aspects of the invention may comprise any one or more of the features mentioned in respect of the first aspect of the invention.

In a fourth aspect, the invention broadly consists in a method of measuring individual logs, each log comprising a log-end face with an applied reference marker of known characteristics, the method comprising: capturing a digital image or images of the log-end face of the log to generate a log-end image capturing the log-end face and reference marker; processing the log-end image to detect or identify the log-end boundary of the log; and generating measurement data associated with the log-end boundary in real-world measurement units based on the known characteristics of the reference marker.

In a fifth aspect, the invention broadly consists in a method of measuring individual logs, each log comprising a log-end face with an applied reference marker of known characteristics, the method comprising: capturing a digital image or images of the log-end space of a log to generate a log-end image of the log-end face and reference marker; and storing and/or transmitting the log-end image or images for subsequent image processing to generate measurement data associated with one or more physical properties of the log-end and real-world measurement units based on the known characteristics of the reference marker.

In a sixth aspect, the invention broadly consists in a method of measuring individual logs, each log comprising a log-end face with an applied reference marker of known characteristics, system comprising: receiving log-end images comprising the log-end face of a log and associated reference marker; processing the log-end image to detect the log-end boundary of the log; and generating measurement data associated with the log-end boundary in real-world measurement units based on the known characteristics of the reference marker.

The methods of the fourth-sixth aspects may be implemented or executed by a processor or processing devices with associated memory.

The methods of the fourth-sixth aspects of the invention may have any one or more features mentioned in respect of the first-third aspects of the invention.

In a seventh aspect, the invention broadly consists in a log measurement system for measuring individual logs, each log comprising a log-end face, the system comprising: an image capture system operable or configured to capture a digital image or images of the log-end face of a log to generate a log-end image capturing the log-end face; and an image processing system that is operable or configured to process the captured log-end image to detect or identify the log-end boundary of the log and generate measurement data associated with the log-end boundary of the log in the log-end image, wherein the image processing system is configured to process the log-end image with an object instance segmentation algorithm based on a convolutional neural network to detect and identify the log-end boundary of the log in the log-end image.

In one form, the object instance segmentation algorithm is based on a regional convolution neural network (R-CNN) algorithm such as, but not limited to, the Fast R-CNN or Faster R-CNN algorithms.

In one configuration, the image processing system is configured to process each log-end image with a mask region convolutional neural network (Mask R-CNN) algorithm to detect the log-end in the image and generate a log-end boundary data or polygon representing the detected or identified log-end in the log-end image. In this configuration, the Mask R-CNN is trained by data or a dataset representing log-end boundary data from log-end images.

In one form, the Mask R-CNN generates log-end boundary data in the form of pixel-level segmentation data. The pixel-level segmentation data represents which pixels in the log-end image belong to the detected log-end or the log-end boundary. The log-end boundary data may be configured to represent either the over-bark log-end boundary, or the under-bark log-end boundary.

In one embodiment, the image capture system comprises a sensor system comprising one or more image sensors. In one configuration, the image capture system comprises a single image sensor. By way of example, the image sensor may be in the form of a digital camera that is operable to capture static and/or moving images. In one configuration, the digital camera is a monochrome camera. In another configuration, the digital camera is a colour camera.

In another embodiment, the image capture system comprises a sensor or sensors or a sensor system operable to capture the log-end images and depth data for each log-end image. In one form, the sensor system may comprise one or more image sensors for generating the log-end images and a depth sensor or sensors for generating the associated depth data for each log-end image. In another form, the sensor system may comprise a stereo camera system that is configured to generate the log-end images and associated depth data. In one embodiment, the sensor system may output digital log-end images with embedded or linked depth data.

In one embodiment, the sensor system of the image capture system is provided in a portable scanning system that is manually operable by an operator or user to capture the log-end images of logs. In this embodiment, the portable scanning system may comprise a handheld imaging device that mounts or carries the sensor system. In this embodiment, the handheld imaging device may comprise a main housing and a handle part or portion for gripping and holding by a user or operator. In this embodiment, the handheld imaging device may further comprise a sensor system controller that is operable to control the operation and settings of the sensor system.

In one embodiment, the image capture system is configured or operable to capture log-end images that each comprise a single log-end of a single log within the image.

In an embodiment, the portable scanning system may comprise a handheld imaging device that is operatively connected for power supply and data communication or transfer to a belt assembly comprising a main controller and power supply. In one configuration, the handheld imaging device is operatively connected to the components of the belt assembly by hardwiring such as cabling. In other configurations, it will be appreciated that the data communication between the handheld imaging device and main controller of the belt assembly may be over a wireless data connection.

In an embodiment, the handheld imaging device may further comprise a guidance system that is operable to project a guidance pattern onto and/or adjacent the log surfaces being imaged to assist the user operating the image capture system. In one configuration, the guidance system may comprise one or more light sources for projecting one or more light patterns onto the log surfaces. In one embodiment, the guidance system may be a laser guidance system to assist the operator during the image capture of the log-end images. The laser guidance system may comprise one or more operable lasers that are operable and configured to project a laser guidance pattern onto the target log-end faces of the logs being imaged. In one configuration, the laser guidance pattern may comprise upper and lower horizontal or parallel laser guide lines or stripes, and a central laser marker or dot located centrally between the upper and lower laser guide lines. In this embodiment, the laser guidance system may be configured to project the laser guidance pattern with reference to the digital camera field of view or otherwise be aligned with or relative to the sensor system field of view.

In an embodiment, the handheld imaging device may further comprise an operable trigger switch to initiate image capture by the sensor system. In one configuration, the operable trigger switch may be configured to initiate the laser guidance system along with the image capture by the sensor system. In one configuration, the trigger switch may be a dual stage switch with the first stage initiating the laser guidance system and initiating the sensory system to automatically adjust its settings ready for image capture, and the second stage initiating the image capture by the sensor system.

In an embodiment, each log comprises a log-end face with an applied reference marker of known characteristics, and the image capture system is operable or configured to capture log-end images capturing the log-end face and reference marker.

In an embodiment, the reference marker is of known shape and dimensions.

In an embodiment, the reference marker may further comprise or is in the form of an ID code representing unique ID information associated with the log to which it is attached. In this embodiment, the reference marker may provide or serve the dual function of providing an ID code for the log and also providing a scaling reference for converting or transforming the data from the 2D image-pixel plane of the captured log-end images to the real-world measurement plane.

In an embodiment, the reference marker is provided on a printed reference ticket that is applied or fixed to the log-end face of the log being imaged.

In an embodiment, the reference ticket may provide an ID code that is distinct or independent of the reference marker. In this embodiment, the reference ticket may comprise a portion that provides the ID code, and a portion that provides the reference marker.

In an embodiment, the reference marker is a one or two-dimensional digital ID code such as a barcode, QR code, two-dimensional matrix code, datamatrix code or the like.

In an embodiment, the reference marker is a 2-D datamatrix code of known size and/or shape. In one configuration, the datamatrix code is provided with distinct corner regions or corners for detection by the image processing algorithms, the locations of the corner regions in the image being used to covert the image-pixel plane data to the real-world measurement plane. By way of example, this conversion or transformation may be via object point of reference photogrammetry techniques or processes.

In an embodiment, the handheld imaging device may comprise a docking cradle or station for receiving a separate portable scanner device that is operable to read ID codes or reference tickets or tags such as barcodes, QR codes, two-dimensional codes, or datamatrix codes for example.

In another embodiment, the image capture system may comprise a robotic system or automatic scanning system that carries the sensor system sequentially one by one relative to the logs of a log load or log pile to sequentially capture a log-end image of each log-end in the log load.

In another embodiment, the image capture system maybe a fixed or stationary image capture station comprising the sensor system, wherein the image capture station is situated or located adjacent a conveyor that moves logs past the image sensor to enable the image sensor to capture an image of the log-end face of each log as it passes the image capture station.

In an embodiment, the image capture system is configured to implement one or more image capture algorithms during the image capture process.

In one embodiment, the image capture algorithm is configured to process a series of log-end images captured by the sensor system of a log-end face until a log-end image of sufficient quality based on predetermined criteria is obtained. In this embodiment, the image capture algorithms may be configured to terminate the image capture process once an image of sufficient quality is obtained for an individual log. In some embodiments, the image processing criteria for an adequate log-end image may comprise any one or more of the following: brightness, sharpness, readability of the ID code, location detection of the reference marker (e.g. corner region location detection) or the like.

In one embodiment, the image capture system may be a separate system that is in data communication with the image processing system. In other embodiments, the image capture system and image processing system may be integrated as a single or integrated log measurement system.

In an embodiment, the image processing system is configured to process the or each log-end image and generate a log-end boundary polygon representing the log-end boundary from which measurement data may be generated for each individual log based on its log-end image. In one embodiment, the log-end boundary polygon generated may represent the overbark log-end boundary. In another embodiment, the log-end boundary polygon generated may represent the underbark log-end boundary at the wood-bark boundary.

In an embodiment, the image processing system may be configured to execute the object instance segmentation algorithm to extract the log-end boundary data or polygon or mask.

In an embodiment, the image processing system is provided with a validation user interface that enables an operator to validate and edit the log boundary polygon generated. In one configuration, the validation user interface displays or presents the log-end image with an overlay or mask of the generated log-end boundary polygon. In one configuration, the validation user interface is operable for a user or operator to edit or adjust or move edge segments of the log-end boundary polygon if required.

In one embodiment, the image processing system is configured to generate measurement data relating to the log-end of the log-end image based on the log-end boundary polygon in the image pixel plane. In this embodiment, the measurement data may be transformed or converted into real-world measurement units associated with a geometric measurement plane based on the depth data associated or linked with each respective log-end image. For example, the image-pixel plane data may be transformed or converted into the measurement plane based on the depth data associated or linked with the log-end image using image transformation algorithms.

In another embodiment, the image processing system may be configured to transform the log-end boundary polygon from the image-pixel plane into a real-world measurement plane based on the depth data associated or linked with each respective log-end image, and then generate real-world measurement data based on the real-world log-end boundary polygon or measurement plane data. In this embodiment, the image-pixel plane data may be transformed or converted into the measurement plane via the depth data using image transformation algorithms.

In an embodiment, the system is configured to detect and define the orientation of a log-face plane relative to the image plane from the log-end image based on depth data linked to the log-end image, and to generate the log-end boundary data based at least partly on the orientation of the detected log-face plane. In one configuration, the log-face plane detection may be implemented in the image capture system. In another configuration, the log-face plane detection may be implemented in the image processing system.

In one embodiment, the log-face plane detection may be implemented by a neural network configured to identify the log-end in the log-end image and process the depth data associated with at least a portion of the identified log-end region in the image to generate orientation data defining or representing the orientation of the log-face of the log-end relative to the image plane of the log-end image.

In an embodiment, the image processing system is configured to rotate log-end boundary data or polygon extracted from the log-end image based on the orientation of the log-face plane to enable real-world measurement data associated with the log-end boundary to be extracted.

In another embodiment, the image processing system is configured to generate measurement data relating to the log-end of the log-end image based on the log-end boundary polygon in the image pixel plane. In this embodiment, the measurement data may be transformed or converted into real-world measurement units associated with a geometric measurement plane based on the reference marker present within the log-end image. For example, the image-pixel plane data may be transformed or converted into the measurement plane via object-point of reference photogrammetry processes with respect to the known reference marker.

In another embodiment, the image processing system may be configured to transform the log-end boundary polygon from the image-pixel plane into a real-world measurement plane based on the reference marker present within the log-end image, and then generate real-world measurement data based on the real-world log-end boundary polygon or measurement plane data. In this embodiment, the image-pixel plane data may be transformed or converted into the measurement plane via object-point of reference photogrammetry processes with respect to the known reference marker.

In one form, the measurement data generated for each log end may comprise any one or more of the following: log end boundary centroid, minor axis, orthogonal axis and log diameters along the determined axes.

In an embodiment, the measurement system is further configured to output and/or store output data representing the measurement data generated for the logs in a data file or memory. In one example, the output data may comprise the log identification ID data and its associated measurement data, and optionally the log-end image and log boundary polygon data generated. In some configurations, the output data of the measurement system may comprise a log count should a batch of log-end images for a log pile or log stack be processed. In this configuration, the log count data may be derived or generated based on the number of unique ID codes or the reference tickets processed, the number of unique log-end boundary polygons generated, or some simply the number of processed log-end images in that there is one log-end image provided for processing for each individual log.

In one form, the output data may be stored in a data file or memory. In another form, the output data may be displayed on a display screen. In another form, the output data is in the form of a table and/or diagrammatic report.

In an embodiment, the logs may be in a log load that is in situ on a transport vehicle when scanned or imaged by the image capture system. The transport vehicle may be, for example, a logging truck or trailer, railway wagon, or log loader. In another embodiment, the logs may be in a log load resting on the ground or another surface, such as a log cradle for example.

In an embodiment, the reference markers are provided on only the small end of each of the logs in the log load.

In an embodiment, the log measurement system further comprises an operable powered carrier system to which the image capture system is mounted or carried, and wherein the carrier system is configured to move the image capture system relative to logs in a log load to image the log-end faces of the logs either automatically or in response to manual control by an operator.

In another embodiment, the log measurement system further comprises a conveyor or carriage system that is configured or operable to transport or move the logs past the image capture system so that the log-end images of the logs may be captured one by one as they pass the image capture system. In this embodiment, the image capture system may be an imaging station adjacent or near the conveyor system such that the image capture system has a field of view of the log-end is of the logs they pass on the conveyor system.

The seventh aspect of the invention may comprise any one or more of the features mentioned above in respect of the first-sixth aspects of the invention.

In an eighth aspect, the invention broadly consists in a log measurement system for measuring individual logs, each log comprising a log-end face, the system comprising: an image capture system operable or configured to: capture a digital image or images of the log-end face of a log to generate a log-end image capturing the log-end face; and store and/or transmit the log-end image or images of the logs for subsequent image processing to generate measurement data associated with one or more physical properties of the log-end, wherein the image processing is configured to process the log-end image with an object instance segmentation algorithm based on a convolutional neural network to detect and identify the log-end boundary of the log in the log-end image.

In a ninth aspect, the invention broadly consists in a log measurement system for measuring individual logs, each log comprising a log-end face, the system comprising: an image processing system operable or configured to: receive a log-end image comprising the log-end face of a log; and process the log-end image to detect the log-end boundary of the log by processing the log-end image with an object instance segmentation algorithm based on a convolutional neural network to detect and identify the log-end boundary of the log in the log-end image; and generate measurement data associated with the log-end boundary of the log in the log-end image.

The eighth and ninth aspects of the invention may comprise any one or more of the features mentioned in respect of the seventh aspect of the invention.

In a tenth aspect, the invention broadly consists in a method of measuring individual logs, each log comprising a log-end face, the method comprising: capturing a digital image or images of the log-end face of the log to generate a log-end image capturing the log-end face; processing the log-end image to detect or identify the log-end boundary of the log by processing the log-end image with an object instance segmentation algorithm based on a convolutional neural network to detect and identify the log-end boundary of the log in the log-end image; and generating measurement data associated with the log-end boundary.

In an eleventh aspect, the invention broadly consists in a method of measuring individual logs, each log comprising a log-end face, the method comprising: capturing a digital image or images of the log-end space of a log to generate a log-end image of the log-end face; and storing and/or transmitting the log-end image or images for subsequent image processing to generate measurement data associated with one or more physical properties of the log-end, wherein the image processing is configured to process the log-end image with an object instance segmentation algorithm based on a convolutional neural network to detect and identify the log-end boundary of the log in the log-end image.

In a twelfth aspect, the invention broadly consists in a method of measuring individual logs, each log comprising a log-end face, the system comprising: receiving a log-end image comprising the log-end face of a log; processing the log-end image to detect the log-end boundary of the log by processing the log-end image with an object instance segmentation algorithm based on a convolutional neural network to detect and identify the log-end boundary of the log in the log-end image; and generating measurement data associated with the log-end boundary.

The methods of the tenth-twelfth aspects may be implemented or executed by a processor or processing devices with associated memory.

The methods of the tenth-twelfth aspects of the invention may have any one or more of the features mentioned in respect of the seventh-ninth aspects of the invention.

In thirteenth aspect, the invention broadly consists in an object measurement system for measuring individual objects, each object comprising a surface or portion of interest with an applied reference marker of known characteristics, the system comprising: an image capture system operable or configured to capture a digital image or images of the object surface to generate an object image capturing the object surface or portion of interest and reference marker; and an image processing system that is operable or configured to process the captured object image to detect or identify regions or contours of interest and generate measurement data associated with those regions or contours of interest in real-world measurement units based on the known characteristics of the reference marker.

In a fourteenth aspect, the invention broadly consists in a method of measuring individual objects, each object comprising a surface of portion of interest with an applied reference marker of known characteristics, the method comprising: capturing a digital image or images of the object surface of the object to generate an object image capturing the object surface or portion of interest and reference marker; processing the object image to detect or identify regions or contours of interest; and generating measurement data associated with those regions or contours of interest in real-world measurement units based on the known characteristics of the reference marker.

In a fifteenth aspect, the invention broadly consists in an object measurement system for measuring individual objects, each object comprising a surface or portion of interest, the system comprising: an image capture system operable or configured to capture a digital image or images of the object surface to generate an object image capturing the object surface or portion of interest; and an image processing system that is operable or configured to process the captured object image to detect or identify regions or contours of interest and generate measurement data associated with those regions or contours of interest in the object image, wherein the image processing system is configured to process the object image with an object instance segmentation algorithm based on a convolutional neural network to detect and identify the regions or contours of interest in the object image.

In a sixteenth aspect, the invention broadly consists in a method of measuring individual objects, each object comprising a surface of portion of interest, the method comprising: capturing a digital image or images of the object surface of the object to generate an object image capturing the object surface or portion of interest; processing the object image to detect or identify regions or contours of interest by processing the object image with an object instance segmentation algorithm based on a convolutional neural network to detect and identify the regions or contours of interest in the object image; and generating measurement data associated with those regions or contours of interest.

The thirteenth-sixteenth aspects of the invention may comprise any one or more of the features mentioned in respect of the log measuring aspects above, as adapted and applied to other objects generally.

In another aspect, the invention broadly consists in a computer-readable medium having stored thereon computer executable instructions that, when executed on a processing device, cause the processing device to perform a method of any of the above aspects of the invention.

Each aspect of the invention above may comprise any one or more of the features mentioned in respect of any of the other aspects of the invention.

### Definitions

The phrase “machine-readable code” or “ID code” as used in this specification and claims is intended to mean, unless the context suggests otherwise, any form of visual or graphical code that represents or has embedded or encoded information such as a barcode whether a linear one-dimensional barcode or a matrix type two-dimensional barcode such as a Quick Response (QR) code, datamatrix code, a three-dimensional code, or any other code that may be scanned, such as by image capture and processing.

The term “pose” as used in this specification and claims is intended to mean, unless the context suggests otherwise, the location and orientation in space relative to a co-ordinate system or reference plane.

The phrase “log load” as used in this specification and claims is intended to mean, unless the context suggests otherwise, any pile, bundle, or stack of logs or trunks of trees, whether in situ on a transport vehicle or resting on the ground or other surface in a pile, bundle or stack, and in which the longitudinal axis of each log in the load is extending in substantially the same direction as the other logs such that the log load can be considered as having two opposed load end faces comprising the log ends of each log.

The phrase “load end face” as used in this specification and claims is intended to mean, unless the context suggests otherwise, either end of the log load which comprises the surfaces of the log ends.

The phrase “log end” as used in this specification and claims is intended to mean, unless the context suggests otherwise, the surface or view of a log from either of its ends, which typically comprises a view of showing either end surface of the log, the log end surface typically extending roughly or substantially transverse to the longitudinal axis of the log.

The phrase “wood-bark boundary” as used in this specification and claims is intended to mean, unless the context suggests otherwise, the log end perimeter or periphery boundary between the wood and any bark on the surface or periphery of the wood of the log such as, but not limited to, when viewing the log end.

The phrase “over-bark log end boundary” as used in this specification and claims is intended to mean, unless the context suggests otherwise, the perimeter boundary of the log end that encompasses any bark present at the log end.

The phrase “under-bark log end boundary” as used in this specification and claims is intended to mean, unless the context suggests otherwise, the perimeter boundary of the log end that extends below or underneath any bark present the perimeter of the log end such that only wood is within the boundary. In most situations, the under-bark log end boundary can be considered to be equivalent to the wood-bark boundary.

The phrase “free-form” as used in this specification and claims in the context of scanning is intended to mean the operator can freely move or manipulate the handheld scanner or imaging device relative to the load end face when imaging the log-end faces of the logs to progressively capture individual log-end images of each log being measured.

The phrase “computer-readable medium” as used in this specification and claims should be taken to include a single medium or multiple media. Examples of multiple media include a centralised or distributed database and/or associated caches. These multiple media store the one or more sets of computer executable instructions. The term ‘computer readable medium’ should also be taken to include any medium that is capable of storing, encoding or carrying a set of instructions for execution by a processor of the mobile computing device and that cause the processor to perform any one or more of the methods described herein. The computer-readable medium is also capable of storing, encoding or carrying data structures used by or associated with these sets of instructions. The phrase “computer-readable medium” includes solid-state memories, optical media and magnetic media.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

The invention consists in the foregoing and also envisages constructions of which the following gives examples only.

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet or mobile device. The term “mobile device” includes, but is not limited to, a wireless device, a mobile phone, a smart phone, a mobile communication device, a user communication device, personal digital assistant, mobile hand-held computer, a laptop computer, an electronic book reader and reading devices capable of reading electronic contents and/or other types of mobile devices typically carried by individuals and/or having some form of communication capabilities (e.g., wireless, infrared, short-range radio, etc.).

### BRIEF DESCRIPTION OF THE DRAWINGS

Preferred embodiments of the invention will be described by way of example only and with reference to the drawings, in which:

FIG. 1 is a schematic diagram of a log measurement system in accordance with an embodiment of the invention;

FIG. 2 is a schematic diagram of an image capture or acquisition system of the log measurement system in accordance with one embodiment of the invention;

FIGS. 3-6 show views of a handheld scanning system or assembly of the image capture system in accordance with an embodiment of the invention;

FIG. 7 shows a view of the handheld scanning system of FIGS. 4-7 in operation scanning a log end;

FIG. 8 is a schematic diagram of an image processing system of the log measurement system in accordance with an embodiment of the invention;

FIGS. 9A and 9B show an image mask and log probability model respectively associated with a cascade classifier of the image processing algorithms for detecting log-ends within captured images for image cropping in accordance with an embodiment of the invention;

FIG. 10 is an example captured log-end image that has been cropped for further processing by the image processing algorithms in accordance with an embodiment of the invention;

FIG. 11 is an image representing the application of an Ultra-metric Contour Map (UCM) generation algorithm to the log-end image crop of FIG. 10 for detecting the over-bark boundary of the log within the image in the image processing algorithms in accordance with an embodiment of the invention;

FIGS. 12A and 12B shows image representations of the UCM generation algorithm applied with varying parameters to the log-end image crop of FIG. 10, in particular showing the UCM generation algorithm applied to generate 50 and 300 targeted regions within the images respectively, in accordance with an embodiment of the invention;

FIGS. 13A-13D shows image representation of the an iterative splitting process applied within the UCM generation algorithm to the log-end image crop of FIG. 10 in accordance with an embodiment of the invention;

FIG. 14 shows an image representation of the labelled split regions output from the splitting process of the UCM generation algorithm as applied to the log-end image crop of FIG. 10 in accordance with an embodiment of the invention;

FIG. 15 shows an image representation of a region scoring process applied to the split region image of FIG. 14 in a region merging process applied to the log-end image crop in accordance with an embodiment of the invention;

FIG. 16 shows a log mask or polygon generated after application of a region merging process of the image processing algorithm to the split region image of FIG. 14 in accordance with an embodiment of the invention;

FIG. 17 shows an image representation of the log mask or polygon of the log-end image crop after a hull repair process is applied to the log mask or polygon generated after the region merging process;

FIG. 18 shows a flow diagram of the image processing of the log-end image using object instance segmentation algorithm based on a CNN to extract the log-end boundary data from the log-end image in accordance with one embodiment of the invention;

FIG. 19 shows an image representation of the log-end image crop with a log mask or polygon representing the log end boundary as generated by the image processing algorithms in accordance with an embodiment of the invention;

FIG. 20 shows a diagram of the log-end polygon generated from the image processing algorithm from a log-end image, and graphically the measured small-end diameter dimensions that are extracted for scaling of the log in accordance with an embodiment of the invention; and

FIG. 21 is a schematic diagram of an image capture or acquisition system of the log measurement system in accordance with another embodiment of the invention in which the sensor system captures log-end images and associated depth data for each log-end image.

### DETAILED DESCRIPTION OF PREFERRED EMBODIMENTS

### 1. Overview

This disclosure primarily relates to embodiments of a log measurement system for the use in measuring parameters of logs. The measurements may be used in the scaling of logs. The measurement system may also be used to gather data for a wider log processing system which includes identifying, counting and/or tracking of logs. The system may also be adapted or modified for measuring other objects, as will be described in later embodiments.

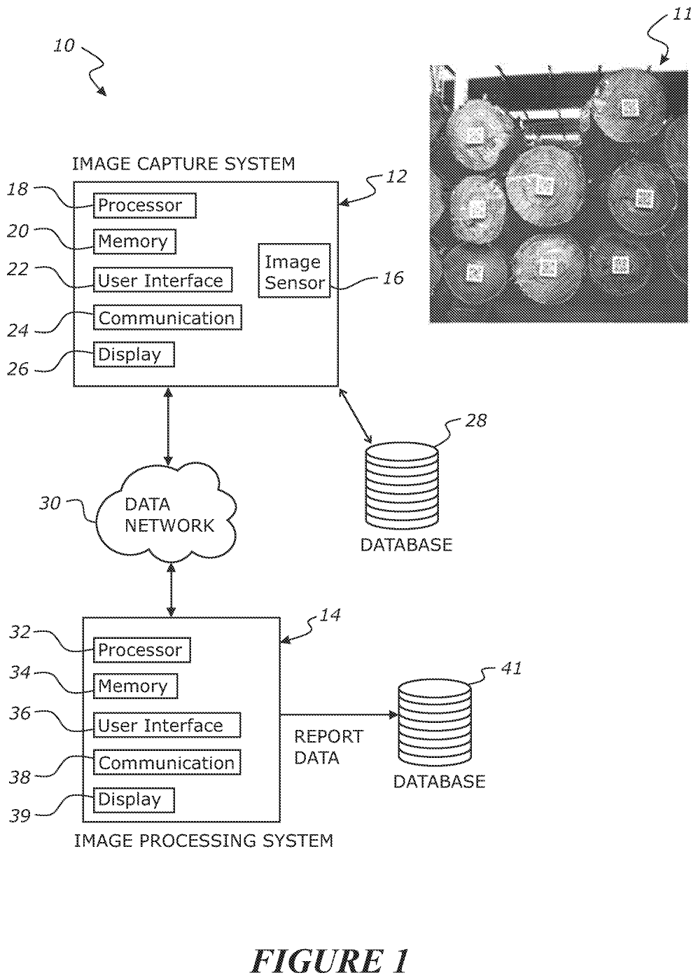

Referring to FIG. 1, an example embodiment of the log measurement system 10 comprises the main components of an image capture or acquisition system 12 and an image processing system 14. The image capture system is configured to capture digital or electronic 2D images of individual log ends of logs within a log load or pile 11 on the ground or on a log transport truck, or logs moving along a conveyor or other transport system. The individual log-end images are processed by the image processing system 14 to identify the individual log, determine the log-end boundary, and extract log-end measurements suitable for making scaling calculations for each individual log. The measurement and/or scaling data may then be output or reported for use in the supply and sale chain as will be appreciated.

In this embodiment, the image capture system 12 typically comprises an image sensor or sensors for capturing individual log-end images of each log 11 being processed. Depending on the configuration, the image capture system typically also comprises a processor 18, memory 20, and user interface 22, communication module 24 and display 24, although not all components are essential in all configurations. In one embodiment, the image capture system utilises object-point of reference photogrammetry to enable the log-end measurements to be converted from an image-pixel plane to a real-world measurement plane, and to compensate for any misalignment between the imaging plane at which the image of the log-end was captured and actual log-end face or surface. For example, if the log-end images are captured by a manually operated handheld imaging device, the imaging plane of the captured image of each log-end may not be co-incident or aligned exactly with the log-end face plane. In this embodiment, a reference object is applied to each log-end to provide the reference for the measurement plane. Typically the reference object is two-dimensional and of a known size and shape, as will be explained in further detail later. In another embodiment, the image capture system comprises a sensor or sensors that are capable of sensing or extracting depth data or information relating to the log-end image of each log, and this depth data is used in the image processing for scaling or converting the log-end measurements from an image-pixel plane to a real-world measurement plane. In such embodiments, a reference object of known characteristics on the log-end is not needed in order to scale and convert the log-end measurements or data into real-world measurement units or into a real-world measurement plane of reference.

As mentioned above, various image capture system configurations and/or arrangements are possible to acquire the log-end images. In a first configuration, the image sensor 16 maybe provided in a handheld scanner or handheld imaging device or assembly which is operated manually by an operator at a logging checkpoint to manually capture the log-end images of each log in a log pile or log load either on the ground or in situ on a logging or transport truck. In another configuration, the image sensor 16 maybe carried by an automated or robotic scanning system or assembly, such as a robotic arm which sequentially captures a log-end image of each log in a log pile or log load by sequentially moving the image sensor 16 adjacent each log-end of each log in the load one by one. For example, the robotic scanning system maybe mobile and transported to a log pile log load situated on the ground for carrying out the scanning and image acquisition process, or alternatively the robotic scanning system may be a fixed or permanent assembly to which a logging or transport truck parks adjacent to enable the robotic scanning system to carry out the image acquisition process. In yet another configuration, the image sensor may be provided in an imaging station in a fixed position relative to a transport system such as a moving conveyor which passes a series of logs one by one past the image sensor of the imaging station to enable the image acquisition process to be undertaken.

In some embodiments, the image capture system may be operatively connected to and in data communication with data storage or a database 28 where acquired log-end images may be either temporarily or permanently stored prior to subsequent transmittal to the image processing system 14.

In some embodiments, the image capture system 12 may be configured to undertake some image processing on each captured log-end image prior to transmitting or sending the image to be image processing system 14. For example, the image capture system may be configured to evaluate the quality of the acquired log-end image and to provide feedback to the image capture system as to the quality of the acquired log end image for subsequent image processing and extraction of the desired log-end measurements. The acquisition feedback data may cause the image capture system to continue to acquire images of the log-end until an adequate log-end image is obtained for further processing.

In an embodiment, the image processing system 14 is configured to receive the log-end images acquired by the image capture system 12 for processing. Typically, the image processing system 14 comprises a processor 32, memory 34, user interface 36, communication module 38 and a display 40. The processor or processor devices 32 of the image processing system 14 are configured to execute or implement image processing algorithms to identify and/or detect the log-end boundary of the log-end captured in each log-end image, and to extract log-end measurements such as the small end diameter from the log-end image which can then be utilised to scale the log with other measurement data such as the length of the log as will be appreciated by a skilled person. The image processing system may be in data communication with or operatively connected to a storage database 42 for storing the acquired and/or processed log-end images for each log and the extracted measurement data for each log for subsequent transmittal to another system or for reporting.

In this embodiment, the image capture system 12 is operatively connected or in data communication with the image processing system 14 to enable the acquired log-end images to be transmitted to the image processing system 14 for extracting log-end measurements and data relating to the log-end for each log scanned or imaged.

In this embodiment, the image capture system 12 may be a separate system to the image processing system 14. It will be appreciated that the image capture system 12 and image processing system 14 may be in data communication via a hardwired data link or a wireless data link or any other data communication network 30. For example, in one configuration, the image capture system 12 may be a portable imaging system at a log checkpoint or processing facility and may transmit or send the acquired log-end images to the image processing system 14 over a data network such as the Internet. The image processing system 14 may be a remote server system or central processing system, such as, but not limited to, a Cloud server or service. In some configurations the image processing system 14 may be configured to receive and process acquired log-end images from a plurality or multiple different image capture systems 12 located at a range of different checkpoint locations.

In other embodiments, the image capture system 12 and image processing system 14 maybe integrated either wholly or partially such that a single system or device in such configurations is capable of both the image acquisition and processing functionality and can generate the log-end measurement data for scaling.

The primary first and second example embodiments below will be described in the context of an image capture system in the form of a portable mobile handheld assembly unit is manually operated to capture log-end images of a log load at a checkpoint for subsequent image processing by the image processing system 14, which typically will be a remote central server system, such as a cloud-based image processing centre. However, it will be appreciated that the primary image acquisition algorithms and image processing algorithms for the extraction of the log-end measurements may also be applied to other configurations or arrangements in which robotic scanning system and/or fixed imaging stations may be utilised.

The following embodiments describe the log measurement system primarily in the context of its main function of extracting log-end measurement data for subsequent scaling of the logs. However, it will be appreciated that the data acquired during the imaging process may also be utilised and identifying, counting and/or tracking of the logs and such supplementary or additional data may be output from the system into a wider logistics or tracking or record-keeping systems.

### 2. First Example Embodiment—Handheld Imaging System for Image Acquisition, Using Reference Object or Markers on Log-Ends for Scaling into Real-World Measurements

2.1 Overview

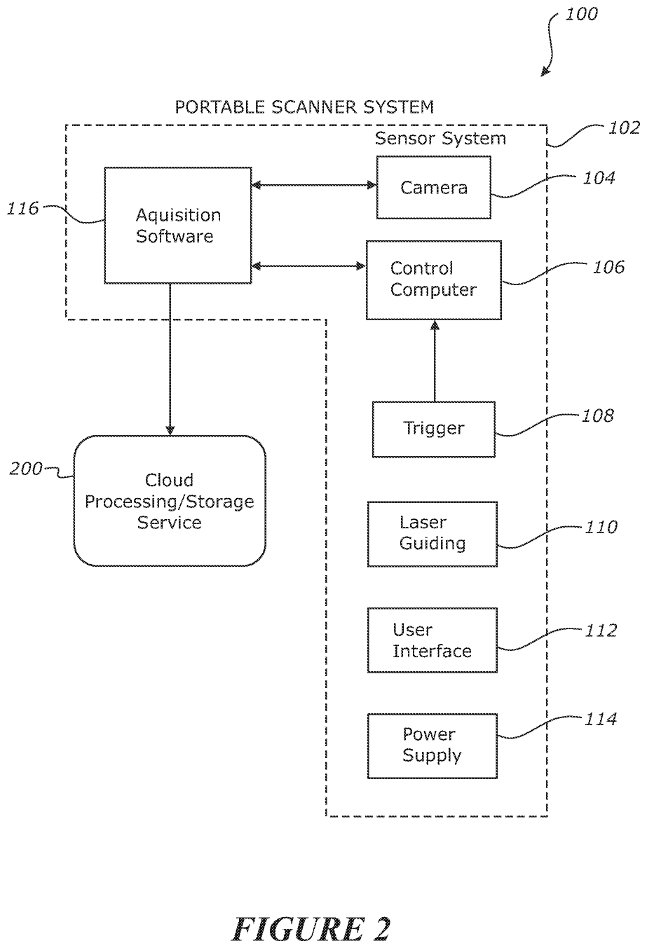

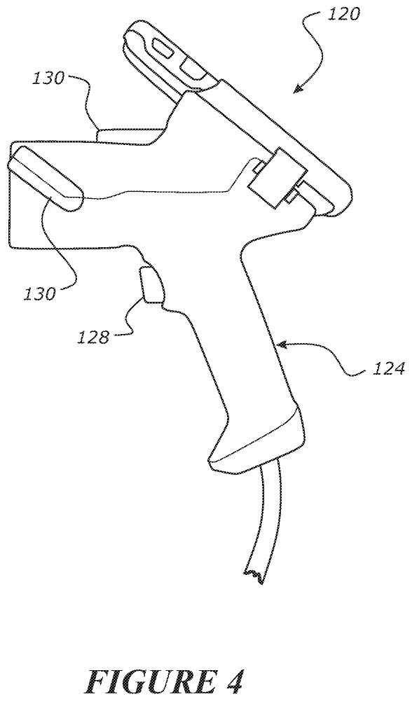

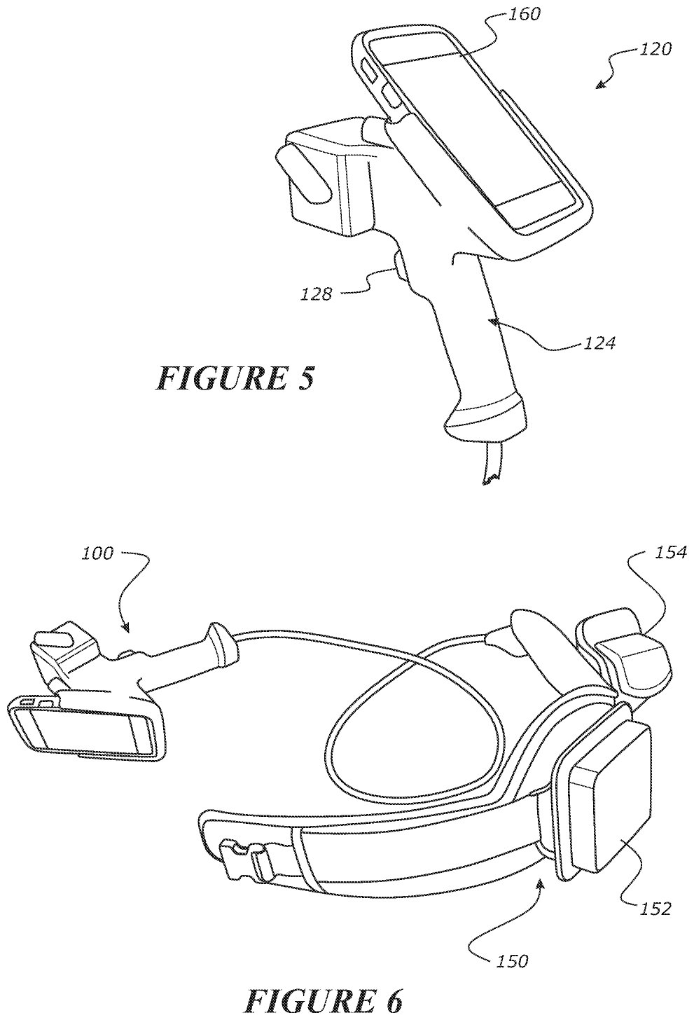

Referring to FIGS. 2-20, the first example embodiment of the log measurement system comprises an arrangement of an image capture system in the form of a handheld imaging assembly or handheld imaging device that is operated by an operator to capture individual log-end images of each log and a log pile or log load on the ground or more typically in situ on a log transport truck or vehicle.

2.2 Ticket Application to Log Ends

In this embodiment, reference objects or reference markers are provided on the end of each log to be measured. In this embodiment, the reference objects are in the form of a two-dimensional reference tag or ticket that is applied typically centrally on the log-end. In particular, the reference tag or ticket is applied to the surface of the small end of each log, typically centrally. The reference ticket or at least a component of the reference ticket is of a known size and shape to enable subsequent identification of the measurement plane of the log-end face during subsequent image processing. Typically, the reference tickets are printed tickets and are applied to the log-end faces via stapling adhesive or other fixing means. By way of example, the reference tickets may be applied to the logs during the log marshalling process, which is required for identification and tracking of logs as will be appreciated by skilled person.

In this embodiment, the reference tickets provide a measurement scale and enable the image processing algorithms to convert the image-pixel plane into a real-world measurement plane, as will be explained further detail later.

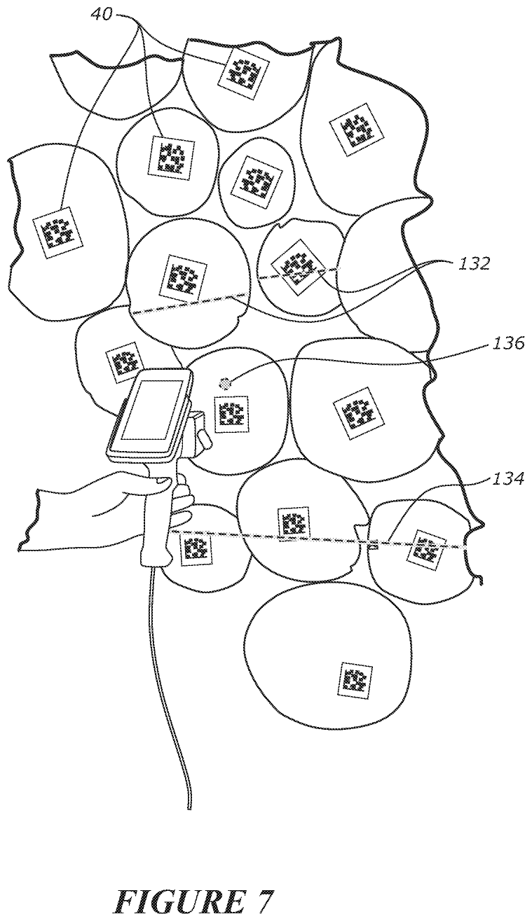

Referring to FIGS. 7 and 10, an example of the reference tickets 40 on the log-end faces is shown. In this embodiment, each reference ticket 40 comprises a reference portion or marker 42 of the known size and shape or known characteristics. In some configurations, the entire reference ticket is the reference marker, but in other configurations only a portion of the surface of the reference ticket may comprise or display the reference marker. In this embodiment, the reference marker 42 also comprises or is in the form of a unique ID code which occupies a portion of the surface area of the reference ticket. For example, the unique ID code may be in the form of a two-dimensional code, such as a two-dimensional barcode or matrix barcode, QR code or the like. The ID code may carry identification data uniquely identifying the log. In this embodiment, by way of example only, the ID code is a datamatrix code that is square in shape comprising dimensions 50 mm×50 mm, although would be appreciated that the shape and dimensions of the ID code may be altered as desired in other embodiments.

In this embodiment, the reference ticket, and particularly the reference marker 42 of the reference ticket 40 performs a dual function of providing unique identification information for the log and also performs the function of providing an object reference of the measurement plane to enable the image processing algorithm to transform the image-pixel coordinates or data of a log-end image into real-world measurement units, such as the metric system in millimetres or metres for example. In alternative configurations, the reference ticket 40 may simply provide a common or homogeneous reference marker 42, and the log-end may comprise a separate ID tag or ticket, such as a datamatrix code, QR code, or 1D barcode for identification scanning in parallel with the log-end image capture. In either configuration, the image capture system should be able to link the log-end image to the identification data associated with that log so that the log-end measurements can be linked or associated to the individual logs respectively.

In this embodiment, the reference ticket may be formed from a material having properties that increases image recognition and readability in regard to the image sensor 16 utilised in the image capture system 12. In this embodiment, the reference ticket 40 is formed from a plastics material having a surface with reduced reflectivity to enhance recognition and readability. For example, the reference tickets may be formed from a Matte plastic and Matte print ribbon. It will be appreciated that the reference tickets may be formed from any other suitable printed material including paper, plastics or otherwise in alternative embodiments.

In this embodiment, the reference tickets are applied to the flat surface of the log ends of the logs being scanned or imaged. Ideally, the reference ticket or at least the reference marker of the reference ticket lies flat or is substantially co-planar with the log-end face planar surface.

2.3 Image Acquisition System

An example image acquisition system configuration will now be described in further detail. In this embodiment, the image capture system 100 of the log measurement system is comprises or is in the form of a portable or mobile handheld imaging system or assembly 102. For example, the image sensor or sensors that are carried or mounted to a handheld imaging device that is manually operated by a user. By way of example only, the handheld imaging device may be operated by an operator at a logging checkpoint or other location where logs are processed or tracked and identified.

Referring to FIG. 2, in this embodiment, the portable scanner system 102 typically comprises at least the components described in respect of the image capture system 12 in the overview. As will be explained in further detail, and this embodiment the portable scanner system 102 comprises an image sensor 104 for capturing images of the log-ends, one or more processors or control computers 106 for controlling the operation of the image data capture and transmission, one or more operable triggers or switches 108, guidance system 110 to assist image capture, a user interface 112, power supply 114 and image capture and control software algorithms 116 operating on the one or more controllers or processes 106.

Handheld Imaging or Scanner Assembly

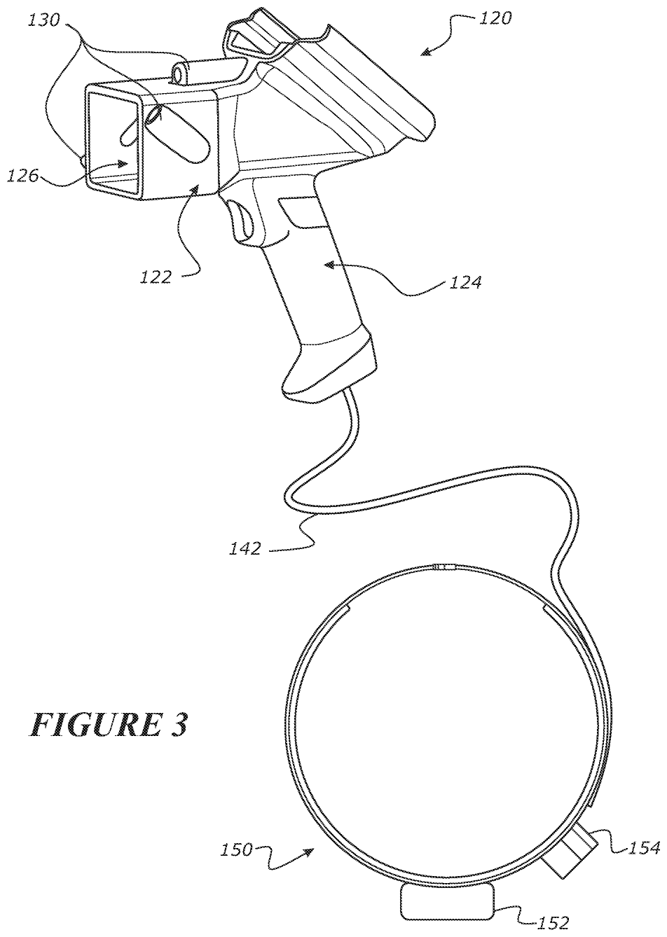

Referring to FIGS. 3-6, the portable scanner assembly 102 will be described in further detail. In this embodiment, referring to FIG. 6, the portable scanner assembly 102 comprises a handheld imaging device 120 that is operatively connected to a belt assembly 150 comprising a control computer and power supply.

Referring to FIGS. 3-5, the handheld imaging device 120 comprises a main body 122 and handle part or portion 124 for gripping of the handheld imaging device 120 by an operator. The main body 122 of the housing comprises an image sensor or sensors 104 in the form of a digital camera. In this embodiment, the digital camera 104 is capable of capturing static texture images or video images comprising a series of images at a configurable frame rate. In this embodiment, the digital camera 104 (not shown) is mounted within the main housing 122 and has a field of view extending outwardly from an opening at the front end of the main housing as indicated at 126. In this embodiment, the digital camera 104 is a monochrome camera generating monochrome images, but it will be appreciated that a colour camera may be used in alternative configurations for colour images. By way of example only, the digital camera 104 in this embodiment is a Basler acA2500-um. The camera has a 1″ global shutter sensor with a 2590×2048 pixel resolution. The Lens used is a Kowa LM6HC with F1.8 and a 6 mm Focal length. A calibration is performed to obtain the cameras intrinsic parameters (radial and tangential distortion). This calibration is leveraged by the software algorithms to remap the log-end images so they are free of or have reduced or minimal distortion.

In this embodiment, the handheld imaging device 120 comprises an on-board camera controller or processing device that controls and interacts with the digital camera 104, such as controlling camera settings and acquisition, and which communicates with the main controller 152 of the belt assembly. In this embodiment, the camera controller of the handheld imaging device is controlled by the main controller 152.

In this embodiment, the handheld imaging device 120 also comprises a guidance system that is operable to project a guidance pattern onto and/or adjacent the log surfaces being imaged to assist the user operating the image capture system. In one configuration, the guidance system may comprise one or more light sources for projecting one or more light patterns or reference projections onto the log surfaces. In this embodiment, the guidance system is a laser guidance system 110 which is configured to provide or project one or more laser or light indicators in the direction of the field of view of the camera, i.e. onto the log-end face or log pile being scanned or imaged. In particular, the laser guidance or reference points assist an operator to align the handheld scanner at the appropriate location relative to a log-end face to acquire a suitable log-end image. In particular, the laser guides assist the operator to locate the handheld imaging device at the required distance range from the log-end face and also to assist the operator to locate the log-end face substantially centrally relative to the field of view of the digital camera 104 of the handheld imaging device 120. As shown, in this embodiment the main housing 122 comprises three laser mounting positions or locations as indicated at 130 at or toward the front end of the handheld imaging device 120 near or adjacent the digital camera mounting position. In this embodiment, the one or more lasers of the laser guidance system 110 are configured to provide a laser guidance pattern for the purposes previously described.

Referring to FIG. 7, in this embodiment, the lasers are configured to provide a laser guidance pattern comprising an upper horizontal laser stripe or line 132 a lower horizontal laser stripe or line 134 and a central laser dot or marker 136 centrally located between the upper and load lower laser stripes 132, 134. In this configuration, the upper and lower laser stripes 132, 134 may be generally aligned with the upper and lower limits of the field of view of the digital camera 104, and the central laser marker 136 may be coaxial or aligned with the centre of the field of view of the digital camera 104. However, it will be appreciated that alternative laser guidance patterns may be projected onto the scanning surface of the log-end in alternative embodiments.

In this embodiment, the handheld imaging device 120 comprises one or more operable buttons or trigger switches 128 better operable by a user to initiate image capture of a log-end face. In particular, the trigger switch 128 initiates image capture by operating the digital camera to capture one or more images of the log-end face, and additionally operates to be laser guidance system. In this embodiment, the handheld imaging device 120 comprises a single trigger or trigger switch 128 mounted or located in the vicinity of the handle part 124 for operation by a finger or fingers of the operator. In this embodiment, the trigger switch 128 when actuated turns on or initiates the lasers of the laser guidance system 110 to project the laser guidance pattern onto the log-end face or scanning surface of the log pile and initiates image capture by the digital camera 104 to capture one or more images of the log-end face.

In this embodiment, the handheld imaging device 120 comprises a two-stage or dual-stage trigger switch 128. Actuation of the first stage of the trigger switch 128 initiates the laser guidance system to project the laser guidance pattern and initiates the digital camera 104 calibrate or adjust camera settings ready for the subsequent image capture. For example, the camera settings may comprise the gain, sensitivity, focus or other camera settings which may be adjusted or configured so as to enable the best quality image to be captured in view of the environment and distance or range of the handheld scanner relative to the log-end face being imaged. The second stage of the trigger switch initiates image capture by the digital camera 104. In this embodiment, the handheld imaging device 120 is configured such that the digital camera 104 continues to take a series of images of the log-end face until an adequate log-end image for further processing is obtained. For example, each log-end image captured of a log-end is evaluated for quality including, but not limited to, assessing the focus of the captured image and assessing adequate recognition of the reference ticket or reference marker (e.g. location detection of the reference marker such as corner region location detection) of the reference ticket for subsequent processing. Once an adequate log-end image is obtained which meets the required log-end image quality thresholds or parameters, the image acquisition for that log-end terminates or ceases and the handheld imaging device may provide a notification or alert to the user that sufficient image acquisition for the log-end has been obtained. The operator feedback or notification may be in the form of an audible (e.g. via a speaker or audio output device), visual (e.g. on a display) and/or tactile (e.g. haptic feedback) notification so that the operator is alerted to the image acquisition for the log-end being complete.

In this embodiment, the handheld imaging device 120 optionally comprises a docking cradle or station or port for mounting an on-board computer or controller or user interface. In this embodiment, the on-board computer is in the form of a portable scanner device 160, such as a Honeywell CT 50 scanner. In this embodiment, the portable scanner device 160 comprises a processor, memory and operable touchscreen display or user interface. In this configuration, the handheld imaging device 120 is provided with redundancy in that the portable scanner 160 may be operated independently of the image capture to manually scan the ID code, such as provided on the reference ticket or a supplementary barcode or similar for the purpose of identifying a log and enabling the user to carry out a manual scale with a scaling ruler to provide and input manual scaling measurements for a particular log should the main image acquisition or capture process fail for any particular log due to log defects or otherwise. The portable scanner device or on-board computer 160 is operatively connected or in data communication with the main control or computer of the belt assembly 150 by hardwiring or wireless data connection. In this configuration, the user interface or touchscreen display of the portable scanner 160 may be utilised to control the settings or parameters of the handheld imaging device 120 or to view captured log-end images and/or to provide a real-time view or display of the field of view of the digital camera 104 if desired.

In this embodiment, the belt assembly comprises a belt that may be worn by user and which mounts or carries a main controller or computer 152 and a power supply 154 in the form of one or more rechargeable battery packs. In this embodiment, the handheld imaging device 120 and belt assembly 150 are hardwired by cabling 142 so that the belt assembly may provide a power supply to the handheld device and to provide data communication between the handheld device 120 and main controller or computer 152 of the belt assembly 150. In this embodiment, the power supply 154 may supply power to the main controller 152 of the belt assembly and the components of the handheld imaging device 120 such as the digital camera 104, lasers of the laser guidance system 110, and the optional on-board portable computer or scanner 160.

In this embodiment, the main controller 152 of the belt assembly 150 is configured to execute or implement the image acquisition or capture algorithms 116, and to operate the digital camera 104 in response to the operation of the trigger switch and/or algorithms. The image capture algorithms will be described in further detail later.

In this embodiment, the main controller 152 of the belt assembly 150 comprises a data communication module or modules to enable data communication across a data network or datalink with one or more external devices or processing devices. In this embodiment, the main controller 152 is configured for wired or wireless data communication. In such configurations, the main controller is configured to transmit or send the acquired or captured log-end images to the image processing system. Typically, the main controller 152 is configured to wirelessly (e.g. Wifi, Bluetooth, RF, infrared, or the like) transmit the acquired log-end image data to the image processing system, either directly or indirectly, over a data network for subsequent processing as a hardwired connection to a dedicated image processing server is not practical when scanning logs at checkpoints typically.

In this embodiment, the main image capture and/or control algorithms are executed by the main controller 152 of the belt assembly. However, it will be appreciated that the software control and algorithms of the portable scanning system 120 may be distributed between one or more processing devices and between the handheld imaging device 120 and belt assembly 150 in different configurations. For example, in some embodiments, the camera controller of the handheld imaging device 120, which may be a dedicated programmable device such as an Application Specific Integrated Circuit (ASIC) or Field Programmable Gate Array (FPGA) or other programmable device, is configured to carry out one or more of the image capture functions or algorithms. For example, in some embodiments, the camera controller of the handheld scanner may be configured to control the camera settings and auto-calibration algorithms prior to image capture. It will be appreciated that any one or more of the programmable devices or controllers on the handheld imaging device 120 may be in data communication with the main controller 152 on the belt assembly 150. It will be appreciated that the main controller of the belt assembly and/or camera controller of the handheld imaging device 120 may have associated memory and/or data storage components or capability for data processing and storage.

In this embodiment, the portable scanning system comprises the handheld imaging device which carries the image sensor or digital camera 104 along with the laser guidance system and operable trigger components, and any other desired peripheral devices such as the auxiliary or supplementary portable computer or scanner device 164, and the belt assembly 150 worn by the operator which comprises the main controller 152 and power supply 154. However, it will be appreciated that an alternative embodiments or configurations, the hardware and software components of the portable scanning system may be integrated into a single handheld unit or device if desired. By way of example only, the components of the belt assembly may be integrated into the handheld imaging device 120 such that the operator simply operates a single handheld device which comprises the digital camera 104, laser guidance system, trigger switch, power supply, and one or more programmable devices or controllers which are executing or implementing the image capture algorithms.

Image Capture Algorithms

As discussed above, the image capture algorithms of the portable scanner system 100 may be carried out by the one or more controllers or processing devices of the portable scanner system 100. As mentioned, in this embodiment the functions of the image capture algorithms may be spread between the controllers of the belt assembly 150 and handheld imaging device 120, or in alternative configurations may be carried out by a single controller on the belt assembly or mounted on the handheld scanner if desired. The image capture algorithms and functions will now be described in further detail by way of example. It will be appreciated that the particular processing device upon which the various functions are carried out is not an essential element of the portable scanning system and may be varied as desired depending on the hardware configuration.

During the image capture of the log-end image for an individual log, the controller or controllers of the portable scanner system 100 generally carry out the following functions:
Camera configuration algorithms,
Image quality evaluation algorithms, and
Log-end image data processing and transmission algorithms.

Camera Configuration Algorithms

In this embodiment, the camera configuration algorithms initiate upon actuation of the first stage of the trigger switch 128 of the handheld scanner. The camera configuration algorithms are configured to control or modify the camera settings ready for image capture or acquisition. By way of example only, the camera configuration algorithms may adjust camera settings such as focus, camera gain, exposure time, brightness, sharpness or other settings. The camera configuration algorithms may initiate upon actuation of the first stage trigger signal or alternatively may be continuously operating when the device is on. Typically, the camera settings are primarily adjusted based on the particular environment and lighting conditions where the logs are being scanned and based on how the operator is manoeuvring the handheld scanner relative to the log-end faces, such as the distance from the log-end faces and/or the angular orientation relative to the log-end faces for example. The camera configuration algorithms may be executing prior to image capture and may also be updating and executing during the image capture process if desired.

Image Quality Evaluation Algorithms

In this embodiment, the image quality evaluation algorithms are configured to evaluate the quality of the log-end images captured by the digital camera 104 upon initiation of image capture, such as actuation of the second stage of the trigger switch 128 of the handheld imaging device 120. The image quality evaluation algorithms are configured to operate on each successive digital log-end image of a log-end face captured by the digital camera 104 until a log-end image of sufficient quality for further processing is obtained. The image quality evaluation algorithms are configured to evaluate the log-end images against one or more image quality criteria or thresholds. It will be appreciated that the image quality criteria may vary depending on the configuration of the system. In this embodiment, the image quality evaluation algorithms assess the images for brightness and sharpness. Additionally, the log-end images are evaluated for readability of the ID code provided on the reference ticket, which in this embodiment is integrated with the reference marker (e.g. Datamatrix code) of the reference ticket, and also based on the detection ability of predetermined location points or location references of the reference marker, such as the four corner region locations of the square datamatrix code in this example. As previously mentioned, the software carries out a camera calibration process to assess the cameras intrinsic parameters and these are utilised by the image acquisition algorithms to correct for lens distortion in the images.

In this embodiment, the image quality evaluation algorithms are executed with respect to the entire log-end image and also separately with respect to the reference ticket and/or reference marker of the reference ticket. For example, it is important that the entire log-end image is of sufficient quality to enable the subsequent log-end boundary detection algorithms to operate. Additionally, it is important that the capture of the reference marker or reference ticket of the log-end image is of sufficient quality to ensure measurement accuracy and knowledge of the camera pose relative to the log face during the image processing to extract the log-end measurement data. As will be explained, the reference ticket is utilised as a known scale to transform the log-end image from the image-pixel plane into a real-world measurement plan for extracting the log-end measurement data, in this example using object point of reference photogrammetry.

In this embodiment, the rectangular or square data matrix code of the reference ticket provides the reference marker 42 for the subsequent image transformation from the image-pixel plane to the measurement plane. As described, the shape and size characteristics of the datamatrix code are known and this enables the image transformation and the subsequent image processing algorithms. To ensure that an accurate image transformation can take place, in this embodiment the image quality evaluation algorithms review the captured image to ensure that the four corner regions or corner locations of the data matrix code are detectable. In this embodiment, a corner region detection algorithm is applied to detect the location of the four corner regions at high accuracy, such as sub-pixel accuracy. However, it will be appreciated that sufficient image transformation may still be obtained with lower resolution of pixel locations for the corner regions. It will also be appreciated that the corner region location detection algorithm and processing may be carried out post-image capture during the image processing phase of the measurement system in alternative embodiments. However, it is generally desirable to carry out the corner region detection algorithm during the acquisition phase or stage to increase the likelihood of the captured log-end image being of sufficient quality to extract accurate log-end measurements during the measurement extraction phase at the image processing system.

As mentioned, the image quality evaluation algorithms continue to process each log-end image captured of a log-end in real-time against the one or more image quality criteria until a log-end image of sufficient quality is captured. The main controller of the portable scanning system allows the digital camera to continue to capture log-end images until an image of sufficient quality is obtained. In parallel, the main controller may send control signals to the camera controller to modify or refine camera settings to further enhance the image quality during the image capture process if required. Upon the detection of an adequate log-end image, the main controller terminates the image capture process and stores the log-end image in memory or local data storage for subsequent processing and/or transmission. As mentioned, the main controller may also initiate a feedback alert to the operator so that they are signalled that a sufficient log-end image has been captured for the log and that they may move to capture an image of the next log on the processing line or log pile. In this embodiment, the main controller is configured to store the log-end image with associated identification data relating to the associated log that was imaged or otherwise links the log's unique identification data to the log-end image.

Log-End Image Data Transmission Algorithms

In this embodiment, the portable scanning system 100 comprises a data transmission algorithm or module that is configured to send or transmit log-end image data captured during the image capture process to the image processing system for subsequent image processing and log-end measurement data extraction. Depending on the configuration, the transmission algorithm may be configured to transmit the log-end image data to the processing system arbitrarily, periodically, on demand, or continuously. As will be appreciated, the log-end data may be sent image by image sequentially, in parallel, in batches, or in one data package file at the end of the scanning process once all logs have been imaged on a log pile being processed for example.

In this embodiment, the log-end image data for each log comprises at least the captured log-end image of the log. Additionally, the log-end image data for each log may also comprise the extracted identification information associated with the log from the ID code within the image and the data indicative of the corner region locations of the reference marker within the reference ticket of the log-end image as determined by the image capture algorithms of the portable scanning system. However, it will be appreciated that the identification information and corner region location information may be extracted directly from the log-end image at the image processing system if desired.

Operator Process—Example

By way of example only, the typical scanning process for a log pile at a checkpoint using the portable scanning system will be described. In brief, the operator of the portable scanning system has an objective of obtaining a log-end image of the log-end face of each individual log of a log pile or log load, for example situated on a log transport truck or situated on the ground or in transit on a logging ship.

For each log, the operator holds the handheld imaging device 120 of the portable scanning system 100 and points it in the general direction of the reference ticket located on the log-end face of the log. Typically, the operator stands within a range of about 1-2 m from the log-end face, but it will be appreciated that the range capability of the handheld imaging device may vary depending on the hardware and software capabilities and configuration. In this embodiment, the operator actuates the first stage of the dual stage trigger 128 of the handheld imaging device 120 which initiates the laser guidance system to project the laser guiding pattern onto the logs. The operator aims to keep the log being imaged within the upper 132 and lower 134 horizontal laser stripes (see FIG. 7) and ideally aims the centre laser marker 136 in the vicinity of the reference ticket at the centre of the log-end face. In some embodiments, the operators are instructed to avoid projecting the laces onto the reference ticket during the image acquisition to avoid the projected lasers distorting the quality of the captured images. However, in other embodiments filtering algorithms may be applied to reduce or minimise the impact of any projected lasers residing on the reference ticket when the log-end images captured.

In this embodiment, the operator is instructed to maintain or align the front end of the handheld imaging device 120 comprising the digital camera 104 as perpendicular to the log-end face as possible. As the operator aligns the log-end face based on the laser guidance pattern and maintaining perpendicular orientation of the device relative to the log-end face, the image capture algorithms may be varying the camera setting parameters to ready the digital camera for image capture such as by altering the focus, gain, and/or other sensitivity settings of the camera. Once the operator is satisfied with the alignment of the handheld scanner relative to the log-end face being imaged, they may actuate the dual stage trigger switch 128 to the second stage to initiate image capture by the digital camera 104. As previously explained, the image capture algorithms continue to process the series of log-end face images being captured by the digital camera until an image of sufficient quality is obtained. In some situations, it may be the first image captured that is of sufficient quality, but in other situations it may take many tens or hundreds of images of the log-end face before a log-end image of sufficient quality is obtained. As will be appreciated, the digital camera 104 may have a high frame rate such as 30 to 50 frames per second and therefore it may only take from a few milliseconds to a few seconds for a sufficient log-end image to be captured for each log generally. As mentioned, once the image processing algorithm determines that a log-end image of sufficient quality has been obtained, an audible, visual and/or tactile feedback notification is provided to the operator to indicate that the image capture process for that particular log is complete. At this point, the operator may release the trigger switch 128 and move to the next log in the log load or pile to repeat the process. Upon release of the trigger switch 128, the log-end image captured for the log is temporarily stored in memory and/or data storage of the portable scanning system (e.g. in memory or data storage associated with the main controller of the belt assembly in this embodiment). As previously explained, the log-end image for the log is typically stored or linked with the log identification information and corner region location information of the reference marker of the reference ticket.

In this embodiment, should the operator fail to obtain an image of sufficient quality for any individual log in a log pile or log load, the operator may abandon image acquisition for that log and may manually capture log-end measurements for the log-end and associate them with the identification information for that log. By way of example only, in this embodiment the handheld imaging device 120 is also provided with a supplementary or auxiliary scanner device 160 that may be operated to scan the ID code on the reference ticket of the log-end face and an interface to enable user-input of manually measured log-end measurements or scaling measurements into the user interface of the scanner device 160 obtained by manually measuring the log-end with a ruler.

Once all log-end faces of the logs on the log pile or log load have been scanned or imaged by the handheld imaging device 120, the log-end measurements may be extracted by the image processing system of the log measurement system. It will be appreciated that the log-end image data may be processed in parallel with the image capture system and some configurations such that the log-end measurements are obtained in real-time or shortly after each log is imaged or alternatively the log-end image data for a batch of logs from a log pile or log load may be processed once of the entire log load has been scanned.

2.4 Image Processing System

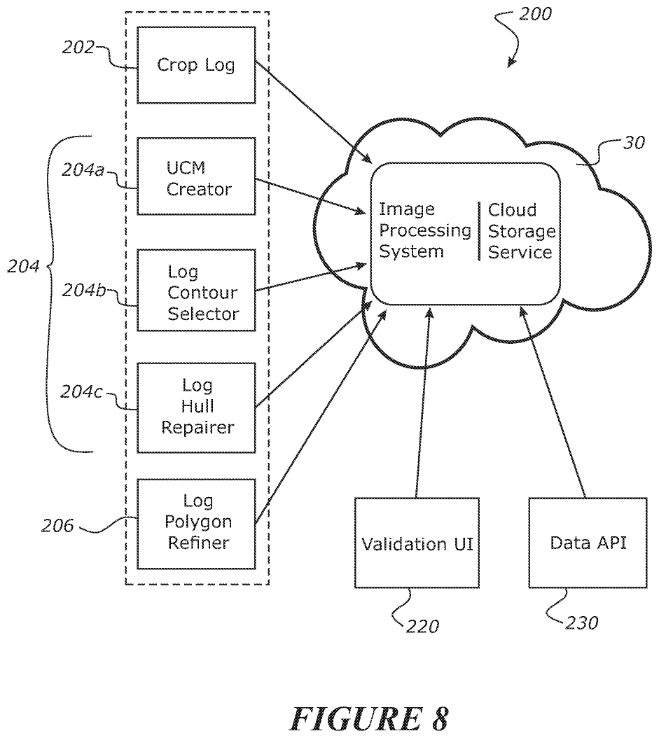

As mentioned above, the log measurement system comprises an image processing system that is configured to process the individual log-end image data captured for each log to extract log-end measurements for scaling and reporting in relation to the logs. An example image processing system 200 will now be described in further detail with reference to FIGS. 8-20.

As discussed, the image processing system 200 comprises components described with reference to the image processing system 14 in FIG. 1. In this embodiment, the log-end image data obtained by the portable scanning system 102 is received by the image processing system either continuously, arbitrarily, periodically, or upon request or demand. Typically, the portable scanner system 102 is configured to transmit or upload the log-end image data for all logs in a processed log load or pile after the image capture process for their log pile is completed by the operator. The image processing system may be a remote data processing center, server or service, operating one or more processing devices, or may be a local data processing device or server in alternative configurations.

Upon receiving a batch of log-end image data for a log pile, the image processing system applies a single or set of image processing algorithms to each log-end image to extract generate log-end measurements for scaling of each log. As previously mentioned, in this embodiment each log scanned comprises respective log-end image data comprising a single log-end image and other data. In the following, various example forms of the image processing algorithms applied to a single log-end image for a single log will now be described in more detail, and it will be appreciated that the same process is repeated on each log-end image for the remaining logs in the log pile to extract measurement data for all logs in the log load or pile.

In this embodiment, the image processing algorithms comprise log boundary detection algorithms, followed by a log boundary validation stage, followed by log polygon or boundary measurement and scaling, as will be further described.

Log Boundary Detection Algorithm(s)—First Example Form—Cascade Classifier and Ultra Metric Contour Map Implementation

Overview

In this first form example embodiment, a series of algorithms are applied to the log-end image to detect and determine the log-end boundary within the captured log-end image. Referring to FIG. 8, in this embodiment the log-end image is firstly subjected to a log area cropping algorithm 202, then over-bark boundary detection algorithms 204, and finally an under-bark boundary detection algorithm 206, as will be explained further in the following. In particular, firstly, the major region in the image where the log-end resides is cropped. Secondly determination of the overbark “outer log” log-end boundary is determined, and thirdly the underbark “wood” log-end boundary is determined.

Log Area Crop

A log area cropping algorithm is applied to the log-end image to remove everything that is obviously not the log being analysed. In this embodiment, the log region detection relies on a “Haar-Like” image feature detection process. In this embodiment, the process uses a Cascade Classifier trained specifically for logs ends. In particular, a machine learning process and Cascade Classifier of Haar-like features, trained on log faces with reference tickets, is used to detect a square region of the log in the log-end image. In some configurations, the fact that the log face is in the middle or central region of the log-end image and has a reference ticket of known image coordinates (reference-ticket corner region location data) is used to select the correct log (if multiple are present in the log-end image).

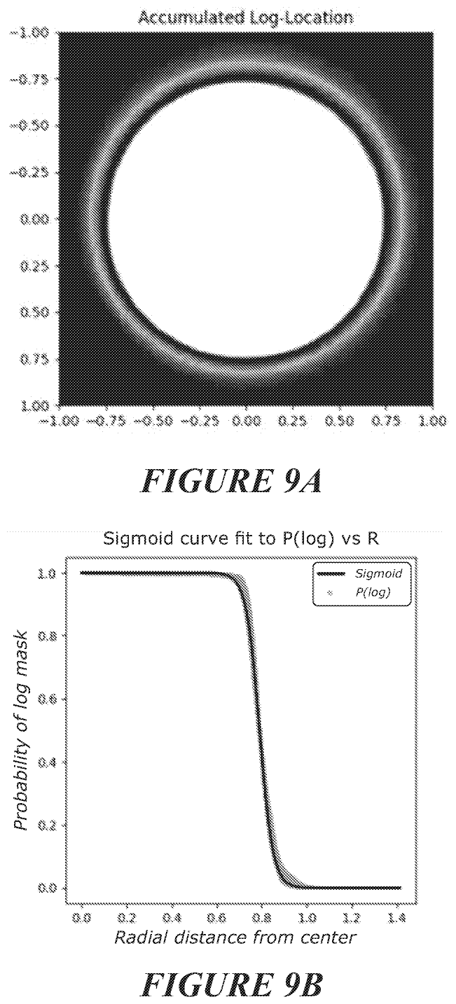

Once the Cascade classifier detects a log in the log-end image, it identifies a square cropping region about the perimeter of the log-end. In this embodiment, through analysis of the trained classifier, a probabilistic view of the expected log location was resolved. By way of example, 1000 Log boundaries were hand traced from the square region detected by the cascade classifier. An image mask was then created at 400×400 resolution and transformed to a cartesian coordinate system and normalised to between −1 and 1 as shown in FIG. 9A. Associated FIG. 9B shows a graph of the log probability model outcome.

The image probability model data (log probability model) or image mask data is created by the Cascade classifier after processing of many images. This image probability model data provides data indicative of or representing the likely regions of interest within the images that are likely to correspond to the contours of interest of the log-end being measured. This image probability model data is used in the later image contour detection and segmentation algorithms to assist in the log-boundary detection within the images, in terms of guiding the selection of the regions of interest, and also scoring and ranking of regions in a splitting and merging process to identify and detect the log-end boundary. As will be appreciated, the probability model is further updated and refined as the cascade classifier processes more log-end images, thereby becoming more accurate from machine-learning as further log-end images are processed.

The output of the log area cropping algorithm is a cropped square image containing the log-end face to be further processed. FIG. 10 shows an example of a source log-end image that has been cropped by the log area cropping algorithm for further processing.

Ultra Metric Contour Map Generation, and Log Contour Selection (Over-Bark Boundary Detection)

The over-bark boundary of the log-end is then determined from the cropped log-end image. In this embodiment, the over-bark boundary detection algorithms utilised image contour detection and segmentation algorithms to identify the over-bark boundary in the cropped log-end image, and also leverage off the image probability model data generated by the cascade classifier.

Various image contour detection and segmentation algorithms may be applied to extract the over-bark log end boundary. However, by way of example, an algorithm based on Ultra-metric contour map (UCM) generation will be described by way of explanation. In particular, in this embodiment, an image contour and segmentation algorithm in the form of gPb-owt-ucm is employed and will be described.

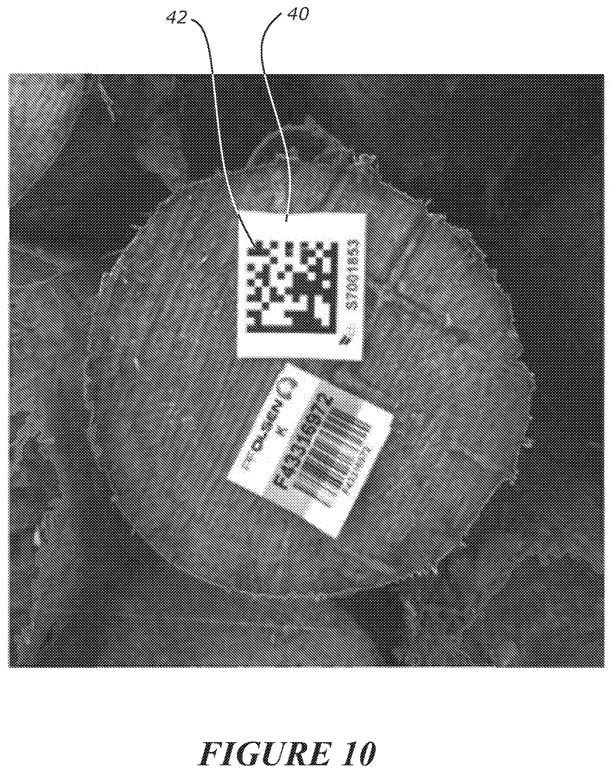

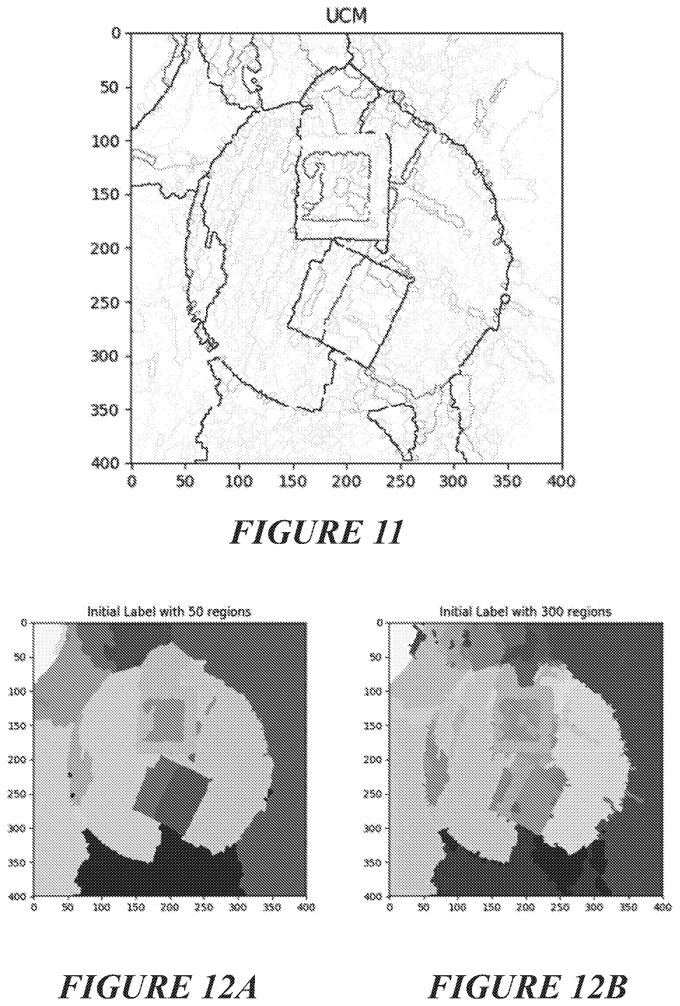

In this embodiment, the over-bark boundary detection relies on gPb-owt-ucm image segmentation. An ultra-metric contour map (UCM) is created, contours are grouped by strength surrounding the detected reference ticket and merged into regions to form the log-end boundary or log polygon. In particular, in order to find the log boundary a map of contours is created (UCM map). This process uses multiple cues in the cropped log-end image region to build the map of contours ranked by their strength. Once the UCM map is created, an algorithm selects interesting contours that are potentially the log boundary. An apriori (image probability model data) has been developed over a large dataset of logs. This dataset is exploited along with the reference ticket location (e.g. corner-region location data) to create an initial ‘overbark’ log-end polygon from the cropped log-end image. Further details of this process are described below with reference to FIGS. 11-16.

Referring to FIGS. 11-12B, the UCM region selection algorithm will be explained. The output of the gPb UCM process creates a 400×400 map of the contours of the image ranked strongest to weakest as shown in FIG. 11. The problem to find the log in this map of contours is knowing what strength the right contours will be and selecting a threshold to gather them. The selection of the initial estimate of the threshold may be problematic because the best threshold varies between images and, for a given image, the best threshold is different for different UCM processing parameters. In this embodiment, the solution adopted to address this is to base the selection of the UCM threshold on a targeted number of contours. In practise, this is approximated in the algorithm by sorting a unique list of UCM boundary strengths and selecting the nth lowest contour. This results in more contours than the target because some contours, though in separate parts of the image, can have the same value in the UCM. There are also a number of degenerate (very small) regions which near the edges of the image. By way of example only, FIGS. 12A and 12B show example images depicting 50 and 300 targeted regions. The threshold of the UCM is altered iteratively by the algorithm until the desired number of regions can be found. It has been discovered that typically a dynamically varying UCM threshold customized to the log-end image being processed generates good results for log-end boundary detection, although it may be possible to use a static or constant UCM threshold in some configurations or scenarios. The UCM is a tree with strong regions containing weaker ones with even weaker ones inside them.

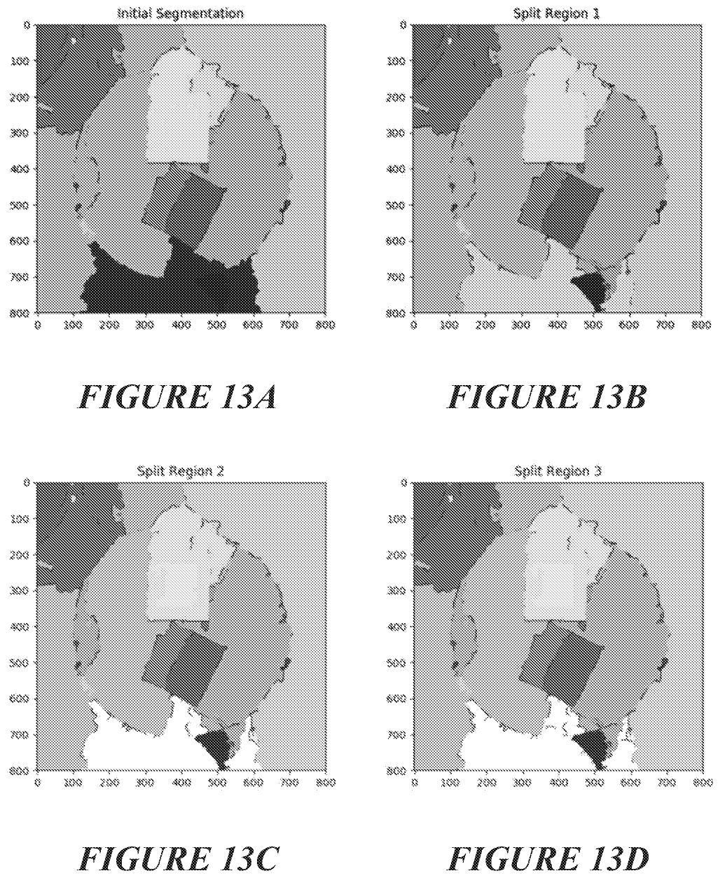

Referring to FIGS. 13A-16, the over-bark log boundary detection algorithm employs a region splitting and merging process to assist in the log boundary detection, and this will be explained further.

In this embodiment, as a means of navigating the UCM tree and allowing local variation of the UCM threshold, the algorithm has been configured such that regions are automatically split according to simple decision criteria. Splitting a region along the next strongest UCM boundary is akin to navigating one branch further down the tree. The process works on a queue so that all initial regions are added to a queue, and as they are evaluated and split, new regions are added to the end of the queue. The split is setup to occur if a region is both inside and outside the annulus given by the log probability model data (from the cascade classifier) previously described with respect to FIGS. 9A and 9B. In this embodiment, the inside and outside regions are determined by thresholding the log probability model. In this embodiment, even if the split condition is met, there are three overriding conditions which prevent over splitting:
1. There are no more divisions possible.
2. The region size is below a minimum threshold. This thresholds determined by a pixel area.
3. The next strongest region is weaker than a threshold. This threshold is determined by selecting the 1000th strongest boundary, so ensuring that there will be no more than 1000 segments.

FIGS. 13A-13D demonstrate the application of this region splitting process to the example cropped log-end image of FIG. 10.

In this embodiment, following the region splitting process, regions in the log-end image are scored according to the criteria which is a weighted sum of the normalised integrated probability of the region, and the deviation of the regions median intensity from the median of a region which is considered a certainty. This certainty is the probablility of the region supporting a boundary according to the log probability model (from the cascade classifier) previously described. The merged regions then generate an initial ‘over-bark’ log end boundary or log-end polygon from the cropped log-end image. In particular, the perimeter of the merged regions defined the log-end polygon. As will be appreciated, the log-end boundary may be defined by a series of pixel co-ordinates or as a function or functions or in any other suitable image data set or format.

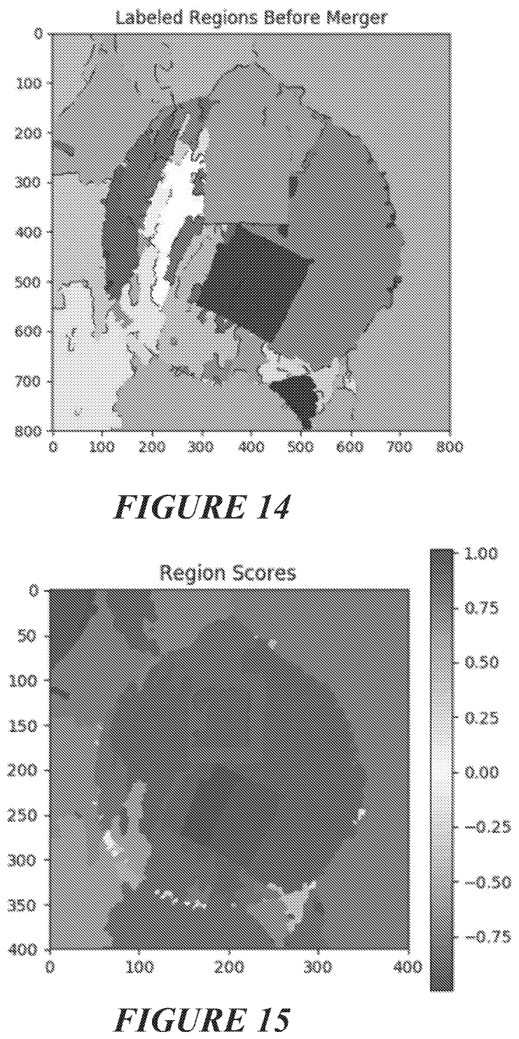

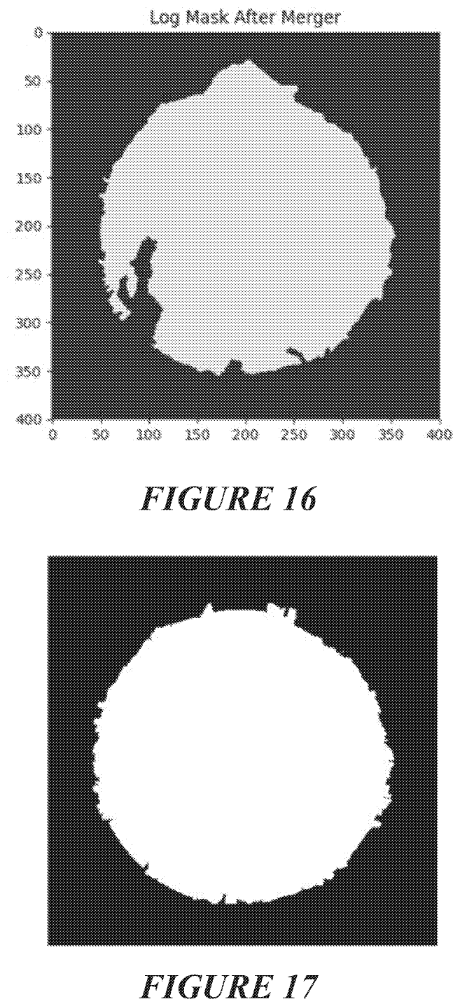

By way of example, FIG. 14 shows the example cropped log-end image after the splitting process has been applied, FIG. 15 shows the log-end image once the region scores have been applied to the regions of FIG. 14, and FIG. 16 depicts the log mask or log hull of the image after the merger of the regions deemed to be the log-end and from which the initial ‘overbark’ log polygon is extracted.

Log Hull Repair

In this embodiment, once the initial ‘overbark’ log-end polygon is created, a log hull repair algorithm is optionally applied to repair any defects in the log “hull”. Defects can be created due to various reasons including, but not limited to, artefacts in the image, mud, stray bark, neighbouring logs, spray paint, extra reference tickets or the like. In this embodiment, the log hull repair algorithm is configured to fit the initial log polygon points to an ellipse with a weighting. Outliers are discarded and neighbouring weaker contours are selected from the UCM data to replace them.

With reference to the example log-end image of FIG. 10 being processed, in the log hull of FIG. 16 there remains a considerable hull defect at the bottom left which creates a concavity in the log. Looking back at the UCM images there are no contours that provides a suitable break point and no strong boundaries. Also, as most of this region is outside the probalistic boundary of the log, it has incurred a negative “merge” score. Similarly consider the top of the log in FIG. 16 where a region has been collected in error as being part of the log-end face.

As the UCM splitting and merging process uses all of the available information in the image it is unlikley that additional information can be extracted from the images. Therefore to remove defects in the hull of the log, the hull repair algorithm in this embodiment is configured to exploit a priori knowledge that logs are approximately elliptical.

In this embodiment, the first step in the hull repair algorithm is to fit an ellipse to the points provided by the log mask in FIG. 16 representing the initial log boundary. The ellipse fitting algorithm attempts to fit all the available data into a model, which is not ideal when outliers exist. To account for outliers, a least squares optimisation algorithm is implemented. The least squares optimiser fits the data iteratively, minimising the error function while attempting to have a best fit model that includes as many inliers, while removing the obvious outliers. The optimiser assumes there are more inliers than outliers, which is a valid assumption since it is not possible to create a model if too few inliers exist. To remove potential outliers from the contour, a parameter, sigma, is defined in the least squares optimiser. The parameter determines the level of confidence in the extracted contours and is measured in pixels. A tuned parameter of 7.5 pixels was selected by way of example, but it will be appreciated this parameter may be varied as desired.

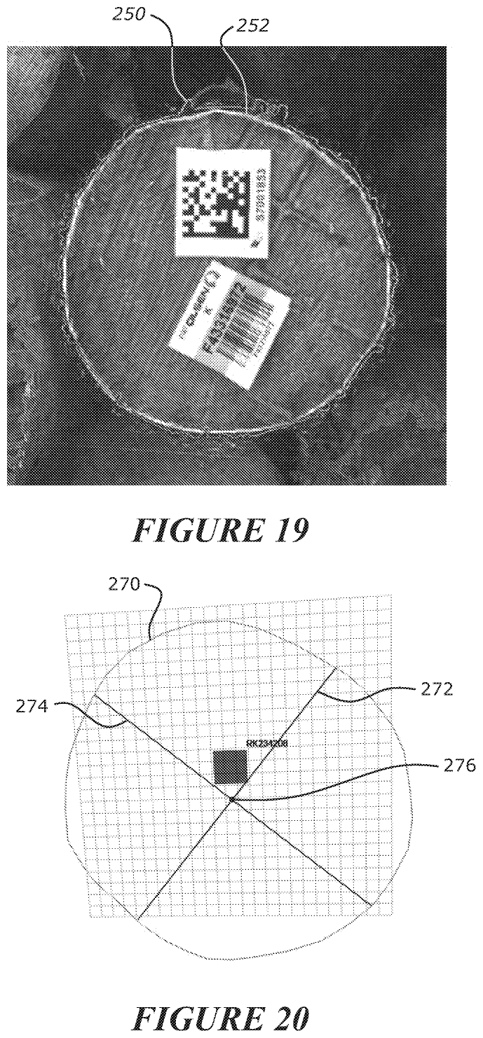

Once outliers are removed, the same ellipse is then leveraged to select and fit contours from the UCM to use in place of the outliers. In this embodiment, for UCM contour data to be considered a candidate, each point must meet two criteria. Firstly, they need to be close to the fitted ellipse model. A distance threshold is defined, and only points which are within a pre-determined distance from the estimated radius are considered. In this embodiment, by way of example only, the default value for the accepted points tolerance was set at 20 pixels. Secondly, only data from regions where no contour mask outline exists are retained. It is assumed that the inliers from the contour mask are the most accurate in estimating the log boundary, and data from the complete UCM should not compete against the contour mask. Based on these two criteria, candidates from the UCM are extracted and applied to the initial log mask to generate a repaired initial log mask as shown in FIG. 17, The repaired log mask or initial ‘overbark’ log end boundary data extracted from the above process is shown at 250 in FIG. 19 overlaid onto the initial cropped log-end image of FIG. 10. By way of comparison, a human identified log-end boundary is also depicted at 252, which is generally inside the log mask line 250.

Log Polygon Refinement (Under-Bark Boundary Detection)

In this embodiment, once the log hull repair algorithm is complete, a log polygon refinement algorithm is applied to refine the log boundary further. In particular, the initial log polygon generated represents the outer over-bark log-end boundary, and the refinement algorithm analyses the image further to generate the inner under-bark log-end boundary representing the interface perimeter of the wood and bark at the log-end.

In this embodiment, the under-bark boundary detection algorithm utilises image segmentation to analyse the image and generate the under-bark log-end boundary from the cropped log-end image. In this embodiment, by way of example, the refinement algorithm utilises or relies on Chan-Vese image segmentation. The process starts from the centre of the log and seeks to find the wood-bark boundary constrained by the outer log boundary.

By way of example only, the refinement algorithm segments the initial log polygon into a series of connected edges or edge lines, and then each edge is sequentially isolated and assessed against the initial cropped log-end image to assess for any fine adjustments needed. It will be appreciated that the number and resolution of the edge lines may be varied as desired. In this embodiment, for each edge line of the log polygon, the algorithm starts at the center of the log in the log image and progresses radially outward toward the edge being analysed and locates using image segmentation the wood-bark boundary. If the wood-bark boundary is not co-incident with the edge of the log polygon, the edge is translated or moved inwardly toward the center to be aligned with the detected wood-bark boundary. This process continues for each edge segment or line of the initial log polygon until each is refined or adjusted as required. The adjusted log polygon can then be said to represent the under-bark log-end boundary.

The output of the above image processing on the cropped log-end boundary is a log polygon or data representing the under-bark log end boundary of the cropped log-end image. As will be appreciated, the pixel co-ordinates of the underbark log-end boundary may be defined by any suitable dataset or function.

The output of the above processing, in this first form example embodiment, may be a composite log-end image comprising the cropped log-end image in combination with the under-bark log-end boundary data. The under-bark log end boundary may also be represented as a graphical overlay on the initial cropped log-end image for viewing and validation as will be explained later.

Log Boundary Detection Algorithm(s)—Second Example Form—Trained Neural Network Implementation

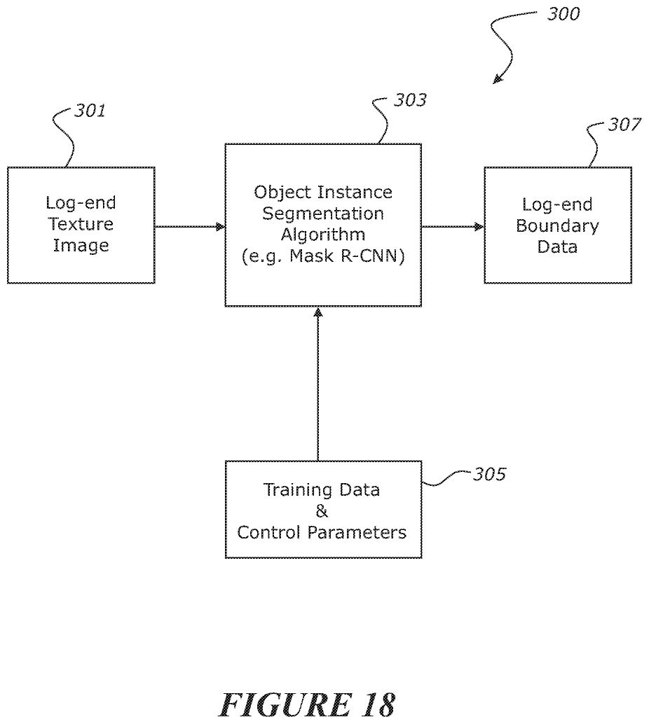

Referring to FIG. 18, an alternative second form example embodiment of the log boundary detection algorithm 300 will be explained. In this second form example embodiment, the log boundary detection algorithm employs a trained neural network algorithm to process each captured log-end image to identify the log-end boundary and generates data or a polygon representing the identified log-end boundary (e.g. the under-bark log-end boundary for example), for further processing and log-end measurement extraction.

In this second form example embodiment, the log-end boundary detection algorithm 300 employs an object instance segmentation algorithm 303 to process and generate the log-end boundary data 307 or polygon from each log-end texture image 301 to be processed. In this example, the object instance segmentation algorithm 303 is based on a convolution neural network (CNN) algorithm. By way of example only, the algorithm is based on a regional convolution neural network (R-CNN) algorithm, such as Fast R-CNN or Faster R-CNN for object detection, which generates classifications and bounding boxes for objects of interest. In this second form example embodiment, the algorithm is a trained Mask R-CNN algorithm that provides pixel-level segmentation of the log-end objects detected in the log-end images. As will be appreciated by a skilled person, Mask R-CNN is an extension of Faster R-CNN in that it additionally provides mask data identifying which pixels are part of the objects detected, thereby a pixel-level segmentation of the image.

As shown in FIG. 18, in this embodiment, the Mask R-CNN object instance segmentation algorithm receives training data and control parameters to customise the algorithm for detection and segmentation of the log-end boundaries within the log-end texture images being processed. As will be appreciated, the Mask R-CNN is a two-stage framework. The first stage scans the texture image and generates proposals (areas likely to contain an object). The second stage classifies the proposals and generates bounding boxes and masks (e.g. pixel-level segmentation).

The log-end boundary data or polygon 307 for each input log-end texture image 301 processed is represented by or extracted from the mask data output from the Mask R-CNN algorithm 303.

As will be appreciated, each captured log-end image is input to the image processing to extract its respective log-end boundary data for the associated log captured in the image. The output of the image processing algorithm may be a composite of the original log-end image 301 comprising the log-end boundary data, or alternatively simply the log-end boundary data and any required data to link or associate that log-end boundary data with the original log-end image or ID data of the associated log, whether directly or indirectly,

Log Boundary Validation

In this embodiment, the image processing system optionally comprises a log boundary validation stage or phase. By way of example, the image processing system comprises a validation user interface 220 that is configured to display the composite cropped log-end image or the original log-end image to an operator to analyse and validate the absence of errors in the shape of the log-end polygon describing the underbark log-end boundary, generated by either of the first or second example embodiment log-end boundary detection algorithms described above. In this embodiment, an operable user interface is provided that allows an operator to correct errors in the log-end boundary overlay or mask if required. FIG. 19 is an example of the type of image the operator may be presented. Additionally, the measurement plane and scaling guides may be shown. The displayed log boundary may be provided with interactive drag handles on it to allow the operator to move the boundary to where it more accurately represents the wood-bark log-end boundary, if required. As will be appreciated, the validation user interface may be provided as a website interface or otherwise a remotely accessible interface to enable trained operators to remote in to the system and carry out a session of validations on processed log-end images. As will be appreciated, the validation interface may comprise a touch-screen interface although a conventional display and computer input devices could alternatively be used to modify the log-end boundary if required.

Once an operator has ‘approved’ the generated log-end boundary determined for a log log-end image, the system is configured to send the composite log-end image with the log-end boundary data to the measurement algorithm explained next.

Log Polygon Measurement

The final step in the image processing algorithm is gathering log-end measurements from the processed log-end image, primarily for the purposed of scaling, such as JAS scaling, or for any other measurement purpose. In particular, JAS scaling data may be generated relating to the log associated with the log-end image by JAS scaling from the underbark log polygon representing the scalable wood at the wood-bark boundary of the log-end.

In one configuration, the measurements can be made or determined in the image-pixel plane of the based on the generated log polygon, and then transformed or transposed from pixel units into real-world units, such as the metric system in millimetres or meters via an image transformation based on the known reference marker, as previously described. In particular, the measurements are transposed from the log-end image through creating a measurement geometric plane from the known reference marker and the detected corner-region locations of the reference marker. In another configuration, the log polygon in the image-pixel plane may be transformed or transposed into a real-world measurement plane such as the metric system via image transformation based on the reference marker, e.g. using object point of reference photogrammetry.

In this embodiment, by way of example, the log measurement is performed on the log polygon after it has been transformed into the real-world geometric measurement plane. By way of example, the measurement algorithm creates the measurement plane based on the detected location co-ordinates of the reference marker of the reference ticket and the known shape and dimensions of the reference marker, which in this example is a square datamatrix code having four corners or corner regions that are detected and located. In this embodiment, the measurement plane is identified by calculating a homography from the detected image coordinates of the corners the datamatrix code to the known model “World” coordinates of datamatrix code. The log-end polygon is the transposed into or onto the measurement plane as shown in FIG. 20 for example. In this embodiment, the real-world log polygon 270 is then assessed on the measurement plane for its centroid 276, minimum diameter through the centroid 272 (small-end diameter) and a perpendicular or orthogonal measurement from the minimum diameter through the centroid. These measurements are returned or recorded in metric units such as meters or millimeters. Data representing the real-world or measurement plane log polygon is also stored. The JAS scaling data for the log may be computed based on the measurements and other data at this point or this data generated later if desired.

At the completion of this process for the log-end image, data comprising or representing the log-end image (cropped or original), log polygon (image-plane and/or measurement plane), log-end diameter measurements and/or scaling data, and log identification information are stored and/or output for further processing. As will be appreciated, that image processing system may be provided with a data API or interface to enable the log-end measurement data to be exported or integrated into other tracking and/or identification systems.

### 3. Second Example Embodiment—Handheld Imaging System for Image Acquisition, Using Depth Data for Scaling into Real-World Measurements

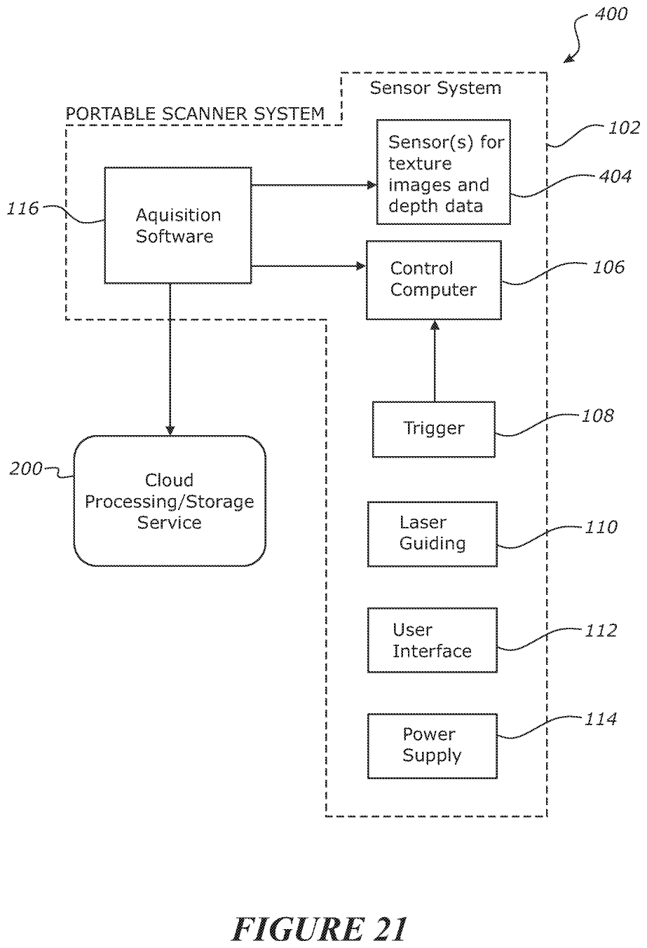

Referring to FIG. 21, a second example embodiment of the log measurement system 400 will be described. This second example embodiment log measurement system is similar to the first example embodiment but does not rely on a reference object (e.g. reference ticket) for any log-face plane perspective correction and/or measurement scale for transforming the pixel data of the log-end boundary into real-world co-ordinates or measurement units. The reference ticket may still be present on the log-end, and used for IDing the log and associating the extracted log-end measurements with the log ID code, but is not required for any perspective correction or scaling of the information into real-world measurement data.

In this second example embodiment of the log measurement system, depth data is captured for each log-end image, is used for any perspective correction and/or scaling into real-world measurement data.

The second example embodiment system 400 is similar to the first example embodiment in that it comprises an image capture system in the form of a handheld imaging assembly or handheld imaging device that is operated by an operator to capture individual log-end images of each log and a log pile or log load on the ground or more typically in situ on a log transport truck or vehicle. As shown in FIG. 21, the primary difference in the hardware of the handheld imaging assembly 400 is that a sensor or sensors (404) are provided that can capture a texture image of each log-end (as before) but additionally depth data associated with each texture image, for example depth data associated with the pixels in the texture image. Like reference numerals represent like components.

It will be appreciated that any sensor or combination of sensors may be used in the portable scanner or imaging system to capture the texture image and depth data of each log-end being processed. In one form, the handheld imaging system may comprise a texture sensor, such as a digital camera 104 as in the first example embodiment, and additionally a separate depth sensor or depth camera, wherein the texture image and depth data are captured simultaneously and fused or linked together. In another form, the handheld imaging system may comprise an image sensor system that is capable of generating both the texture image and depth data, such as a stereo camera system. In this form, the stereo camera system is capable of capturing a texture image of each log-end and generating associated depth data or a depth image for each texture image.

The operation, image capture process and image processing algorithm of the second example embodiment system 400 is largely the same as that described above with respect to the first example embodiment, and all alternatives and variants described are also applicable to this second example embodiment. The primary difference in the image capture and processing algorithms is that the depth data associated with each log-end texture image is used for log-face perspective correction and/or to scale the log-end boundary data or polygon into real-world measurements, as will be explained further below in the example implementation. For example, in regard to scaling into real-world co-ordinates, the texture image of each log-end boundary is processed as described with respect to the algorithms of first embodiment above to generate the log-end boundary data or polygon in the image. This log-end boundary data is then further processed by the log polygon measurement algorithm with respect to the depth data of the associated original log-end image to generate the log-end measurements with respect to a real-world geometric measurement plane.

In particular, in this second embodiment system, the reference ticket (if optionally present in the image, e.g. for IDing purposes) is not required for any log-face plane perspective correction or scaling or transforming the log-end boundary data or polygon of the image-pixel plane to a real-world measurement plane. In this second embodiment, the depth data associated with the original texture image is used for log-face plane perspective correction and to scale or transform the log-end boundary data or polygon from the image-pixel plane to a real-world measurement plane. As with the first embodiment, in one implementation, the log-end measurements can be extracted from the log-end boundary data or polygon in the image-pixel plane, and then that measurement data transformed or converted from pixel units into real-world units (such as the metric system in millimetres or meters) using an image transformation based on the depth data associated with the original log-end texture image. Alternatively, in another implementation, the log-end measurements are performed on the log-end boundary data after it has been transformed or converted into the real-world geometric measurement plane using image transformation based on the depth data. An example of one particular implementation of the use of the depth data in the image capture and image processing algorithms will be further explained below.

Example Implementation and Use of Depth Data

The implementation of the image capture and image processing algorithms using the depth data is provided by way of example only. In this example implementation, the depth data obtained for each log-end image is used for two purposes. Firstly, the depth data is used during the image capture process by the handheld imaging system 400 for log-face plane identification and/or detection. Secondly, the depth data is subsequently used in the image processing system for scaling or transforming the log-end boundary data from the image-pixel plane to a real-world measurement plane or world co-ordinates to provide the measurement data for the log-end boundary in real-world measurement units. These two aspects of the depth data are explained further in the following.

In one configuration, the controller and image capture algorithms of the handheld imaging system are configured to execute an optimised neural network image processing algorithm, such as a regional convolution neural network, to detect the log-end in a captured log-end image of the log-end and generates a bounding box about the log-end in the image. The image capture algorithm is then configured to mask-out or exclude all depth data that is not within the generated bounding box from further processing. In one configuration, the bounding box and its associated depth data is designated as the “region of interest” (RoI) and the algorithm is configured to de-project all the depth data points in the RoI into a 3D point cloud and fit the depth data points to a ‘log-face’ plane defined by a centroid point and a normal vector, i.e. orientation data defining the log-face plane relative to the original image plane. In another configuration, which may provide faster processing, the RoI may be a portion or subset of the original bounding box, and then processed in a similar way to define the log-face plane, thereby reducing the number of depth data points for processing. It will be appreciated that this log-face plane detection algorithm may be implemented in real-time during the image capture process. If a log-face plane is not detected to predetermined criteria, an alert or feedback may be generated for the operator of the handheld imaging system to re-capture a better image of the log-end from a different angle. Alternatively, the log-face plane detection algorithm may be implemented within the image processing algorithms in the image processing system.

The log-end image and associated depth data, which may be the original depth data in combination with data representing the detected log-face plane in the log-end image or alternatively the data representing the detected log-face plane without the original depth data, is then subsequently processed by the image processing algorithms, such as the log boundary detection algorithms, in accordance with any of the previous embodiments described to detect and identify the log-end boundary data or polygon in the log-end texture image. The detected log-face plane is then used as a reference to rotate, if required, the log-end boundary data or points or polygon as if the log-end boundary data was extracted from a log-face plane that was perpendicular or normal to the image sensor Z-axis. The rotated log-end boundary data is then passed to the scaling algorithm to extract the measurement data in accordance with the previous embodiments described.

The output data from the image processing algorithms in this second example embodiment is the same as that described with respect to the first example embodiment. For example, the image processing algorithms may output data comprising or representing the log-end image (cropped or original), log polygon or log-end boundary (image-plane and/or measurement plane), log-end diameter measurements and/or scaling data, and log identification information are stored and/or output for further processing.

The above first and second example embodiments relate to a log measurement system configuration comprising an image capture system that utilises a portable scanning system such as a hand-held manually operable scanner unit or device carrying the digital camera or image sensor(s) for capturing the image log-end images of the individual logs being measured, and any depth data for each image as in the second example embodiment. However, it will be appreciated that in alternative embodiments or configurations the log measurement system may capture the log-end images (and any depth data in the case of the second example embodiment) robotically or via fixed scanning systems or other configurations some examples of which will be described in the following alternative embodiments.

### 4. Third Example Embodiment—Robotic Imaging Assembly

In this alternative embodiment, the log measurement system may be configured to capture the log-end images (and the associated depth data for each image in the case of the second example embodiment) using a robotic scanner rather than a user manually imaging the log-ends with a portable handheld scanning or imaging unit. By way of example only, the digital camera or imaging sensor(s) or sensor system of the image capture system may be mounted to or carried by a robotic arm or robotic assembly that is operable to automatically to move the digital camera or image sensor(s) or sensor system sequentially or progressively adjacent each log-end of the logs in a log pile or log stack one at a time, and sequentially capture a log-end image of each log (and any associated depth data for each image in the case of the second example embodiment). As will be appreciated, the robotic assembly may be configured to operate next to a log pile or log stack provided on a transport truck or vehicle. In this configuration, the robotic imaging assembly may be a permanent or fixed assembly which the log transport trucks may park next to during the imaging process. In other configurations, the robotic imaging assembly may be mobile or provide on a transport vehicle that can be parked next to a fixed log pile or log stack for example on the ground to carry out the imaging process of the log-ends. In other words, the robotic scanning assembly may be fixed relative to a mobile log stack, or vice versa in which the robotic imaging assembly is mobile and may be moved or transported to a log pile or log stack for image processing of that log pile or log stack.

In some configurations, the robotic scanning assembly may comprise one or more boom assemblies, each of which carries one or more image sensors. The boom assemblies may comprise one or more arms and actuators to enable the boom assembly to be moved relative to the log-end faces of the log stack to capture the required log-end images (and any associated depth data for each image as in the case of the second example embodiment). As will be appreciated, the boom assembly or assemblies may be mounted to or provided on a framework or support structure, which may be fixed or mobile depending on the application of whether the log-end images are captured of a log stack on the back of a log truck or imaging of a log stack situated on the ground. In some configurations, the boom assembly may be moved and manipulated automatically, and in other configurations the movement of the boom assembly may be manually controlled via a remote control system or similar.

In this embodiment, the robotic imaging assembly may comprise a plurality of image sensors or digital cameras or sensor systems to speed up the imaging process of a log stack. For example, two or more digital cameras operating on independent robotic arms or robotic scanning assemblies may operate in parallel to image the log-ends in a log pile.

As will be appreciated, the image capture algorithm is implemented by the robotic scanning imaging system or assembly may be the same as that described in respect of the portable scanning system in the first and second embodiments. Likewise, the image processing algorithms carried out by the image processing system may also be identical to those described with respect to the first and second embodiments. The main difference in this robotic imaging assembly configuration is the means of obtaining the log-end images robotically as opposed to manually buy a hand-held operator. As will be appreciated, the robotic scanning assembly may comprise one or more sensors and operable actuators for moving the image sensor or sensor system relative to the log-ends to capture the required log-end images (and depth data in the case of the second embodiment system) for further processing, including maintaining a suitable distance from the log-ends for adequate image capture.

### 5. Fourth Example Embodiment—Static Imaging Station and Conveyor

In this alternative embodiment, the image capture system may be provided in the form of a fixed imaging station or device that is located adjacent a log transport machine, such as a conveyor system or similar. The imaging station may carry out the functions of the image capture system described with respect to the previous embodiments.

By way of example, the imaging station may comprise a stationary image sensor or digital camera or sensor system located or situated adjacent a moving conveyor system. The conveyor system may be configured to carry or transport logs one at a time past the imaging station such that the imaging station can capture a log-end image of each log (and depth data in the case of the second embodiment configuration). As with the previous embodiments, the image capture algorithms and image processing algorithms are primarily the same as previously described in the previous embodiments.

In this embodiment, the imaging station is configured to capture the log-end image data (any depth data in the case of the second embodiment configuration) of the individual logs and send or transmit that directly or indirectly over a data network or data communication link to an image processing system of the type previously explained.

As with the previous embodiments, it will be appreciated that the image capture functions carried out by the imaging station may also be integrated or combined with the image processing algorithms carried out by the image processing system. In such a configuration, the imaging station may function as the measurement system by carrying out both the image capture and image processing algorithms to generate the log-end measurement data for subsequent storage transmission and/or reporting to other computing or data centre processing systems.

### 6. Object Measuring System

The previous embodiments have described the measurement system as applied to a log measurement system for generating log-end measurement data in logging applications in the forestry industry. However, it will be appreciated that the image capture system and image processing system may be modified or adapted to suit measuring characteristics or physical properties of other objects or items. The other objects or items may be natural products or alternatively manufactured components or items which have variability due to machine tolerances and/or the manufacturing process.

By way of example only, it will be appreciated that the function of the image capture system for other objects would also be to capture a two-dimensional image of the surface or portion of the object to be measured along with the reference marker for converting or transforming the image pixel plane to a geometric measurement plane in real-world measurement units in the case of the first embodiment, or alternatively additionally depth data for each image as in the case of the second embodiment configuration. The image capture algorithms may again be adapted to refine or modify the image sensor or digital camera or sensor system settings during image capture and to evaluate image quality of the object images for further processing to extract measurement data in a similar manner described in respect of the log measurement system.

Similar to the log measurement system embodiments, the image processing system or functionality processes the object images to detect and identify measurement regions of interest relating to the objects of interest, similar to the log-end boundaries in the context of the log measurement system. As will be appreciated, in accordance with the first example image processing algorithms, the object images may be cropped to an area of interest and then subject to a contour detection and image segmentation algorithm to identify the contours of interest for measurement. As will be appreciated, the cascade classifier used in the image cropping may be modified and trained based on the objects being imaged and to develop an object probability model similar to that described with respect to the log measurement system. That object probability model may be then used in the image segmentation algorithm and in the splitting and merging process to assist in identifying the contours or object polygons of interest for subsequent measurement.

As with the log measurement system, additional refinement algorithms and/or repair algorithms may be applied to correct for any artefacts or defects in the images which cause defects to the contour regions or polygons of interest for measurement. Alternatively, in accordance with the second example image processing algorithms, an object instance segmentation algorithm based on a region convolution neural network, such as Mask R-CNN, may be implemented to generate polygons or mask data at the pixel-level for detected objects of interest.

Additionally, an optional human verification user interface may also be used to check or approve that the identified contour regions of interest are accurate relative to the object image as described in the context of the log measurement system. As will be appreciated, various measurement data may be extracted based on the detected contours or polygons and the required measurement data required for the object of interest such as, but not limited to, diameters, surface area measurements, dimension measurements, thickness measurements, angular measurements or otherwise.

As with the image processing algorithms described in the context of the log measurement system, the contour detection data (e.g. object polygons) and measurement data may be derived in the image-pixel plane of the object image and then transformed into the real-world measurement plane based on the reference marker transformation or depth data (as in the case of the second embodiment configuration), or alternatively the contour detection data may be transformed or transposed into the real world geometric measurement plane based on the reference marker or depth data, and then subsequently the measurement data extracted from the measurement plane.

It will be appreciated that any of the various image capture configurations, including the portable imaging system, robotic imaging system, or imaging station configurations may be applied in the context of other objects of interest depending on the application and industry.

### 7. General

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in the figures may be rearranged and/or combined into a single component or embodied in several components without departing from the invention. Additional elements or components may also be added without departing from the invention. Additionally, the features described herein may be implemented in software, hardware, as a business method, and/or combination thereof.

In its various aspects, the invention can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

The foregoing description of the invention includes preferred forms thereof.

Modifications may be made thereto without departing from the scope of the invention as defined by the accompany claims.

1. A log measurement system for measuring individual logs, each log comprising a log-end face with an applied reference marker of known characteristics, the system comprising:
an image capture system operable or configured to capture a digital image or images of the log-end face of a log to generate a log-end image capturing the log-end face and reference marker; and
an image processing system that is operable or configured to process the captured log-end image to detect or identify the log-end boundary of the log and generate measurement data associated with the log-end boundary in real-world measurement units based on the known characteristics of the reference marker.

2. A log measurement system according to claim 1 wherein the image capture system comprises a sensor system comprising one or more image sensors being operable to capture the log-end images.

3. A log measurement system according to claim 1 or claim 2 wherein the image capture system comprises a sensor system being operable to capture the log-end images and depth data for each log-end image.

4. A log measurement system according to claim 3 wherein the sensor system comprises one or more image sensors for generating the log-end images and a depth sensor or sensors for generating the associated depth data for each log-end image.

5. A log measurement system according to claim 3 wherein the sensor system comprises a stereo camera system that is configured to generate the log-end images and associated depth data for each log-end image.

6. A log measurement system according to any one of the preceding claims wherein sensor system of the image capture system is provided in a portable scanning system that is manually operable by an operator or user to capture the log-end images of logs.

7. A log measurement system according to claim 6 wherein the portable scanning system comprises a handheld imaging device that mounts or carries the sensor system.

8. A log measurement system according to claim 7 wherein the handheld imaging device comprises a main housing and a handle part or portion for gripping and holding by a user or operator, and a sensory system controller that is operable to control the operation and settings of the sensor system.

9. A log measurement system according to claim 7 or claim 8 wherein the handheld imaging device further comprises a guidance system that is operable to project a guidance pattern onto and/or adjacent the log surfaces being imaged to assist the user operating the image capture system.

10. A log measurement system according to claim 9 wherein the guidance system is a laser guidance system that comprises one or more operable lasers that are operable and configured to project a laser guidance pattern onto the target log-end faces of the logs being imaged.

11. A log measurement system according to claim 10 wherein the handheld imaging device further comprises an operable trigger switch to initiate image capture by the sensor system and wherein the operable trigger switch is further configured to initiate the laser guidance system along with the image capture by the sensor system.

12. A log measurement system according to any one of claims 7-11 wherein the handheld imaging device further comprises a docking cradle or station for receiving a separate portable scanner device that is operable to read or scan ID codes or reference tickets.

13. A log measurement system according to any one of the preceding claims wherein the image capture system is configured or operable to capture log-end images that each comprise a single log-end of a single log within the image.

14. A log measurement system according to any one of claims 1-5 wherein the image capture system comprises a robotic system or automatic scanning system that carries the image sensor sequentially one by one relative to the logs of a log load or log pile to sequentially capture a log-end image of each log-end in the log load.

15. A log measurement system according to any one of claims 1-5 wherein the image capture system is a fixed or stationary image capture station comprising the sensor system, wherein the image capture station is situated or located adjacent a conveyor that moves logs past the sensor system to enable the sensor system to capture an image of the log-end face of each log as it passes the image capture station.

16. A log measurement system according to any one of the preceding claims wherein the reference marker is of known shape and dimensions, and comprises or is in the form of an ID code representing unique ID information associated with the log to which it is attached, and wherein the reference marker serves the dual function of providing an ID code for the log and also providing a scaling reference for converting or transforming the log-boundary data from a 2D image-pixel plane of the captured log-end image to a real-world measurement plane.

17. A log measurement system according to claim 16 wherein the reference marker is provided on a printed reference ticket that is applied or fixed to the log-end face of the log being imaged, and wherein the reference marker is a 2-D datamatrix code of known size and/or shape and which is provided with distinct corner regions or corners for detection by the image processing algorithms for converting or transforming the log-boundary data from the image-pixel plane to the real-world measurement plane.

18. A log measurement system according to any one of the preceding claims wherein the image capture system is configured to implement one or more image capture algorithms during the image capture process, and wherein one image capture algorithm is configured to process a series of log-end images captured by the sensor system of a log-end face until a log-end image of sufficient quality based on predetermined criteria is obtained for further processing to extract the log-end boundary data.

19. A log measurement system according to any one of the preceding claims wherein the image capture system is a separate system that is in data communication with the image processing system.

20. A log measurement system according to any one of claims 1-18 wherein the image capture system and image processing system is integrated as a single or integrated log measurement system.

21. A log measurement system according to any one of the preceding claims wherein the image processing system is configured to process the or each log-end image and generate a log-end boundary polygon representing the log-end boundary from which measurement data is generated for each individual log based on its log-end image.

22. A log measurement system according to claim 21 wherein the log-end boundary polygon generated represents the overbark log-end boundary.

23. A log measurement system according to claim 21 wherein the log-end boundary polygon generated represents the underbark log-end boundary at the wood-bark boundary.

24. A log measurement system according to any one of the preceding claims wherein the image processing system is configured to process each log-end image with an image processing algorithm in the form of an object instance segmentation algorithm to generate log-end boundary data representing the detected or identified log-end in the log-end image.

25. A log measurement system according to claim 24 wherein the object instance segmentation algorithm is based on a convolution neural network (CNN) algorithm.

26. A log measurement system according to claim 24 or claim 25 wherein the image processing system is configured to process each log-end image with a mask region convolutional neural network (Mask R-CNN) algorithm to detect the log-end in the image and generate log-end boundary data representing the detected or identified log-end in the log-end image.

27. A log measurement system according to claim 26 wherein the Mask R-CNN algorithm generates log-end boundary data in the form of pixel-level segmentation data, the pixel-level segmentation data representing which pixels in the log-end image belong to the detected log-end or the log-end boundary.

28. A log measurement system according to any one of the preceding claims wherein the image processing system is configured to generate measurement data relating to the log-end of the log-end image based on the log-end boundary data in the image pixel plane, and wherein the measurement data is transformed or converted into real-world measurement units associated with a geometric measurement plane based on depth data associated or linked with each respective log-end image.

29. A log measurement system according to any one of claims 1-27 wherein the image processing system is configured to transform the log-end boundary data from the image-pixel plane into a real-world measurement plane based on depth data associated or linked with each respective log-end image, and then generate real-world measurement data based on the log-end boundary data in the real-world measurement plane.

30. A log measurement system according to any one of claims 1-27 wherein the system is configured to detect and define the orientation of a log-face plane relative to the image plane from the log-end image based on depth data linked to the log-end image, and to generate the log-end boundary data based at least partly on the orientation of the detected log-face plane.

31. A log measurement system according to any one of claims 1-27 wherein the image processing system is configured to generate measurement data relating to the log-end of the log-end image based on the log-end boundary data in the image pixel plane, and wherein the measurement data is transformed or converted into real-world measurement units associated with a geometric measurement plane based on the reference marker present within the log-end image.

32. A log measurement system according to any one of claims 1-27 wherein the image processing system is configured to transform the log-end boundary data from the image-pixel plane into a real-world measurement plane based on the reference marker present within the log-end image, and then generate real-world measurement data based on the log-end boundary data in the real-world measurement plane.

33. A log measurement system according to any one of the preceding claims wherein the measurement data generated for each log end comprises any one or more of the following: log end boundary centroid, minor axis, orthogonal axis and log diameters along the determined axes.

34. A log measurement system according to any one of the preceding claims wherein the measurement system is further configured to output or store output data representing the measurement data generated for the logs in a data file or memory.

35. A log measurement system according to any one of the preceding claims wherein the log measurement system further comprises an operable powered carrier system to which the image capture system is mounted or carried, and wherein the carrier system is configured to move the image capture system relative to logs in a log load to image the log-end faces of the logs either automatically or in response to manual control by an operator.

36. A log measurement system according to any one of the preceding claims wherein the log measurement system further comprises a conveyor or carriage system that is configured or operable to transport or move the logs past the image capture system so that the log-end images of the logs are captured one by one as they pass the image capture system.

37. A method of measuring individual logs, each log comprising a log-end face with an applied reference marker of known characteristics, the method comprising:
capturing a digital image or images of the log-end face of the log to generate a log-end image capturing the log-end face and reference marker;
processing the log-end image to detect or identify the log-end boundary of the log; and
generating measurement data associated with the log-end boundary in real-world measurement units based on the known characteristics of the reference marker.

38. A log measurement system for measuring individual logs, each log comprising a log-end face, the system comprising:
an image capture system operable or configured to capture a digital image or images of the log-end face of a log to generate a log-end image capturing the log-end face; and
an image processing system that is operable or configured to process the captured log-end image to detect or identify the log-end boundary of the log and generate measurement data associated with the log-end boundary of the log in the log-end image,
wherein the image processing system is configured to process the log-end image with an object instance segmentation algorithm based on a convolutional neural network to detect and identify the log-end boundary of the log in the log-end image.

39. A log measurement system according to claim 38 wherein the object instance segmentation algorithm is based on a regional convolution neural network (R-CNN) algorithm.

40. A log measurement system according to claim 38 or claim 39 wherein the image processing system is configured to process each log-end image with a mask region convolutional neural network (Mask R-CNN) algorithm to detect the log-end in the image and generate log-end boundary data representing the detected or identified log-end in the log-end image.

41. A log measurement system according to claim 40 wherein the Mask R-CNN algorithm generates log-end boundary data in the form of pixel-level segmentation data that represents which pixels in the log-end image belong to the detected log-end or the log-end boundary.

42. A log measurement system according to any one of claims 38-41 wherein the log-end boundary data is configured to represent the over-bark log-end boundary

43. A log measurement system according to any one of claims 38-41 wherein the log-end boundary data is configured to represent the under-bark log-end boundary.

44. A log measurement system according to any one of claims 38-43 wherein the image capture system comprises a sensor system comprising one or more image sensors being operable to capture the log-end images.

45. A log measurement system according to any one of claims 38-43 wherein the image capture system comprises a sensor system operable to capture the log-end images and depth data for each log-end image.

46. A log measurement system according to claim 45 wherein the sensor system comprises one or more image sensors for generating the log-end images and a depth sensor or sensors for generating the associated depth data for each log-end image.

47. A log measurement system according to claim 45 wherein the sensor system comprises a stereo camera system that is configured to generate the log-end images and associated depth data for each log-end image.

48. A log measurement system according to any one of claims 38-47 wherein sensor system of the image capture system is provided in a portable scanning system that is manually operable by an operator or user to capture the log-end images of logs.

49. A log measurement system according to claim 48 wherein the portable scanning system comprises a handheld imaging device that mounts or carries the sensor system.

50. A log measurement system according to claim 49 wherein the handheld imaging device comprises a main housing and a handle part or portion for gripping and holding by a user or operator, and a sensory system controller that is operable to control the operation and settings of the sensor system.

51. A log measurement system according to claim 49 or claim 50 wherein the handheld imaging device further comprises a guidance system that is operable to project a guidance pattern onto and/or adjacent the log surfaces being imaged to assist the user operating the image capture system.

52. A log measurement system according to claim 51 wherein the guidance system is a laser guidance system that comprises one or more operable lasers that are operable and configured to project a laser guidance pattern onto the target log-end faces of the logs being imaged.

53. A log measurement system according to claim 52 wherein the handheld imaging device further comprises an operable trigger switch to initiate image capture by the sensor system and wherein the operable trigger switch is further configured to initiate the laser guidance system along with the image capture by the sensor system.

54. A log measurement system according to any one of claims 49-53 wherein the handheld imaging device further comprises a docking cradle or station for receiving a separate portable scanner device that is operable to read or scan ID codes or reference tickets.

55. A log measurement system according to any one of claims 38-54 wherein the image capture system is configured or operable to capture log-end images that each comprise a single log-end of a single log within the image.

56. A log measurement system according to any one of claims 38-47 wherein the image capture system comprises a robotic system or automatic scanning system that carries the image sensor sequentially one by one relative to the logs of a log load or log pile to sequentially capture a log-end image of each log-end in the log load.

57. A log measurement system according to any one of claims 38-47 wherein the image capture system is a fixed or stationary image capture station comprising the sensor system, wherein the image capture station is situated or located adjacent a conveyor that moves logs past the sensor system to enable the sensor system to capture an image of the log-end face of each log as it passes the image capture station.

58. A log measurement system according to any one of claims 38-47 wherein the reference marker is of known shape and dimensions, and comprises or is in the form of an ID code representing unique ID information associated with the log to which it is attached, and wherein the reference marker serves the dual function of providing an ID code for the log and also providing a scaling reference for converting or transforming the log-boundary data from a 2D image-pixel plane of the captured log-end image to a real-world measurement plane.

59. A log measurement system according to claim 58 wherein the reference marker is provided on a printed reference ticket that is applied or fixed to the log-end face of the log being imaged, and wherein the reference marker is a 2-D datamatrix code of known size and/or shape and which is provided with distinct corner regions or corners for detection by the image processing algorithms for converting or transforming the log-boundary data from the image-pixel plane to the real-world measurement plane.

60. A log measurement system according to any one of claims 38-59 wherein the image capture system is configured to implement one or more image capture algorithms during the image capture process, and wherein one image capture algorithm is configured to process a series of log-end images captured by the sensor system of a log-end face until a log-end image of sufficient quality based on predetermined criteria is obtained for further processing to extract the log-end boundary data.

61. A log measurement system according to any one of claims 38-60 wherein the image capture system is a separate system that is in data communication with the image processing system.

62. A log measurement system according to any one of claims 38-60 wherein the image capture system and image processing system is integrated as a single or integrated log measurement system.

63. A log measurement system according to any one of claims 38-62 wherein the image processing system is configured to process the or each log-end image and generate a log-end boundary polygon representing the log-end boundary from which measurement data is generated for each individual log based on its log-end image.

64. A log measurement system according to claim 63 wherein the log-end boundary polygon generated represents the overbark log-end boundary.

65. A log measurement system according to claim 63 wherein the log-end boundary polygon generated represents the underbark log-end boundary at the wood-bark boundary.

66. A log measurement system according to any one of claims 38-65 wherein the image processing system is configured to generate measurement data relating to the log-end of the log-end image based on the log-end boundary data in the image pixel plane, and wherein the measurement data is transformed or converted into real-world measurement units associated with a geometric measurement plane based on depth data associated or linked with each respective log-end image.

67. A log measurement system according to any one of claims 38-65 wherein the image processing system is configured to transform the log-end boundary data from the image-pixel plane into a real-world measurement plane based on depth data associated or linked with each respective log-end image, and then generate real-world measurement data based on the log-end boundary data in the real-world measurement plane.

68. A log measurement system according to any one of claims 38-65 wherein the system is configured to detect and define the orientation of a log-face plane relative to the image plane from the log-end image based on depth data linked to the log-end image, and to generate the log-end boundary data based at least partly on the orientation of the detected log-face plane.

69. A log measurement system according to any one of claims 38-65 wherein the image processing system is configured to generate measurement data relating to the log-end of the log-end image based on the log-end boundary data in the image pixel plane, and wherein the measurement data is transformed or converted into real-world measurement units associated with a geometric measurement plane based on the reference marker present within the log-end image.

70. A log measurement system according to any one of claims 38-65 wherein the image processing system is configured to transform the log-end boundary data from the image-pixel plane into a real-world measurement plane based on the reference marker present within the log-end image, and then generate real-world measurement data based on the log-end boundary data in the real-world measurement plane.

71. A log measurement system according to any one of claims 38-70 wherein the measurement data generated for each log end comprises any one or more of the following: log end boundary centroid, minor axis, orthogonal axis and log diameters along the determined axes.

72. A log measurement system according to any one of claims 38-71 wherein the measurement system is further configured to output or store output data representing the measurement data generated for the logs in a data file or memory.

73. A log measurement system according to any one of claims 38-72 wherein the log measurement system further comprises an operable powered carrier system to which the image capture system is mounted or carried, and wherein the carrier system is configured to move the image capture system relative to logs in a log load to image the log-end faces of the logs either automatically or in response to manual control by an operator.

74. A log measurement system according to any one of claims 38-73 wherein the log measurement system further comprises a conveyor or carriage system that is configured or operable to transport or move the logs past the image capture system so that the log-end images of the logs are captured one by one as they pass the image capture system.

75. A method of measuring individual logs, each log comprising a log-end face, the method comprising:
capturing a digital image or images of the log-end face of the log to generate a log-end image capturing the log-end face;
processing the log-end image to detect or identify the log-end boundary of the log by processing the log-end image with an object instance segmentation algorithm based on a convolutional neural network to detect and identify the log-end boundary of the log in the log-end image; and
generating measurement data associated with the log-end boundary.
